(19) United States
(12) Patent Application Publication
(10) Pub. No.: US 2025/0102346 A1
(43) Pub. Date: Mar. 27, 2025

(54) LEVEL METER

(71) Applicant: Keyence Corporation, Osaka (JP)

(72) Inventors: Satoru TOMOSHI, Osaka (JP); Motoki OZAKI, Osaka (JP)

(73) Assignee: Keyence Corporation, Osaka (JP)

(21) Appl. No.: 18/785,075

(22) Filed: Jul. 26, 2024

(30) Foreign Application Priority Data
Sep. 25, 2023 (JP) 2023-159390

(51) Int. Cl. G01F 23/284; G01F 23/80; G01F 25/20

(52) U.S. Cl. CPC G01F 23/2845; G01F 23/804; G01F 25/20

(57) ABSTRACT

Provided is a level meter capable of correctly measuring a level of an object stored in a container. The level meter includes a distribution determination unit, an extraction unit, a candidate determination unit, and a display portion. The distribution determination unit determines the reception intensity distribution of the reflection signal with respect to the distance from the level meter based on the reception intensity of the reflection signal due to reflection of the measurement signal. The candidate determination unit extracts a plurality of combinations of the peak position and the peak intensity from the reception intensity distribution by the extraction unit, and determines the combinations as a plurality of peak candidates. The display portion displays a candidate confirmation screen including the measurement value corresponding to each of the plurality of peak candidates and the reception intensity scale related to the reception intensity.

### CROSS-REFERENCE TO RELATED APPLICATIONS

The present application claims foreign priority based on Japanese Patent Application No. 2023-159390, filed Sep. 25, 2023, the contents of which are incorporated herein by reference.

### BACKGROUND OF THE INVENTION

### 1. Technical Field

The present invention relates to a level meter that measures a level of an object.

### 2. Description of the Related Art

In a container that stores a flowable substance such as a liquid, a powder, or a granular material, a level meter that measures a height of an interface of the substance, that is, a level (liquid level, powder upper surface level, etc.) may be used.

The level meter described in JP 2014-002091 A includes a probe to which a pulse signal is input, and measures a level based on a pulse input to the probe and a pulse reflected by a measurement target.

Depending on the type of the level meter, a signal such as a radio wave may be transmitted from the level meter toward the object without using a probe in order to measure the level of the object stored in the container. The level meter can measure the level based on the transmitted signal and the signal reflected at the interface of the object.

However, there may be an element that reflects a signal other than the interface of the object inside the container. For example, in a case where a stirrer for stirring the object is provided in the container, the stirrer may reflect the signal. In a case where the container is, for example, a large tank, a ladder for an operator to perform work in the tank may be provided. Ladders in the tank may also reflect the signal. In addition, in a case where the object is a substance (oil or the like) that easily transmits a signal, the signal may transmit the object, and the signal may be reflected at the bottom of the container.

When there is an element that reflects a signal other than the interface of the object, the level meter cannot correctly measure the level of the object unless the signal reflected at the interface of the object is distinguished from the other signals.

### SUMMARY OF THE INVENTION

In view of the above problems, an object of the present invention is to provide a level meter capable of correctly measuring a level of an object stored in a container.

In order to solve the above problem, a level meter as an example of an embodiment according to the present invention is a level meter that measures a level of an object stored in a container, the level meter including: a transmission/reception unit including a transmission circuit that transmits a measurement signal for measuring the level and a reception circuit that receives a reflection signal due to reflection of the measurement signal; a distribution determination unit that determines a reception intensity distribution of the reflection signal with respect to a distance from the level meter based on a reception intensity of the reflection signal received by the reception circuit; an extraction unit that extracts a peak position and a peak intensity from the reception intensity distribution determined by the distribution determination unit; a measurement value determination unit that determines a measurement value related to a distance or the level of the object based on the peak position extracted by the extraction unit; a candidate determination unit that extracts a plurality of combinations of the peak position and the peak intensity by the extraction unit from the reception intensity distribution determined by the distribution determination unit and determines the combinations as a plurality of peak candidates; and a display portion that displays information on the measurement value and the reception intensity corresponding to each of the plurality of peak candidates determined by the candidate determination unit.

According to the present invention, the plurality of peak candidates extracted from the reception intensity distribution of the reflection signal is displayed on the display portion. These peak candidates include a peak corresponding to the level of the object and a peak corresponding to an element other than the object. By selecting a peak corresponding to the level of the object from the peak candidates, the level meter can correctly measure the level by distinguishing the signal reflected at the interface of the object from the other signals. The level meter can optimally set the setting of the measurement condition necessary for determining the measurement value related to the level of the object based on the reception intensity distribution and the peak corresponding to the level of the object. By setting the measurement condition optimally, the level meter can maintain a state in which the level is correctly measured.

### BRIEF DESCRIPTION OF THE DRAWINGS

FIG. 1 is a perspective view illustrating a level meter;

FIG. 2 is a cross-sectional view of the level meter;

FIG. 3 is a view illustrating a state in which the level meter is attached to a container that contains an object;

FIG. 4 is a block diagram schematically illustrating an example of a relationship between components of the level meter;

FIG. 5 is a view illustrating an example of a configuration of a radar control unit and a transmission/reception unit;

FIG. 6 is a view illustrating a relationship between a measurement signal and a reflection signal;

FIG. 7 is a graph illustrating a reception intensity distribution in a case where a plurality of peaks occurs;

FIG. 8 is a view illustrating a state transition of the level meter;

FIG. 9 is a view illustrating a menu screen;

FIG. 10 is a view illustrating a state transition of the level meter in an adjust function;

FIG. 11 is a flowchart illustrating a flow of processing in an optimization mode;

FIG. 12 is a view illustrating setting contents according to a diagnosis result;

FIG. 13 is a flowchart illustrating a flow of processing in a limited mode;

FIG. 14 is a view illustrating an adjust mode selection screen;

FIG. 15 is a view illustrating a wait screen;

FIG. 16 is a view illustrating a candidate selection message;

FIG. 17 is a view illustrating a candidate confirmation screen;

FIG. 18 is a view illustrating a suggestion message in a case where an influence of an ambient signal is large;

FIG. 19 is a view illustrating a calculation result confirmation screen of a near distance measurement limit;

FIG. 20 is a view illustrating a suggestion message in a case where the calculation result of the near distance measurement limit is not preferable;

FIG. 21 is a view illustrating a start confirmation screen of optimization processing;

FIG. 22 is a view illustrating an optimization completion screen;

FIG. 23 is a view illustrating a display screen of the presence or absence of a learning execution result;

FIG. 24 is a view illustrating an erasure necessity confirmation screen of a learning execution result;

FIG. 25 is a view illustrating an execution confirmation screen of learning;

FIG. 26 is a view illustrating a numerical value input screen related to a distance;

FIG. 27 is a view illustrating a learning completion screen;

FIG. 28 is a perspective view illustrating another example of the level meter;

FIG. 29 is a view illustrating another example of a current value display screen;

FIG. 30 is a view illustrating another example of a candidate confirmation screen;

FIG. 31 is a view illustrating another example of an optimization completion screen;

FIG. 32 is a perspective view illustrating still another example of the level meter;

FIG. 33 is a view illustrating a screen transition of the display portion of a remote controller in the adjust function; and

FIG. 34 is a view illustrating screen transition of the display portion of the remote controller in the limited mode.

### DETAILED DESCRIPTION

Hereinafter, embodiments of the present invention will be described with reference to the drawings. Note that, in the drawings, the same or corresponding portions are denoted by the same reference numerals, and the description thereof will not be basically repeated. In addition, in the following description, terms meaning positions or directions such as front, back, left, right, upper, and lower may be used, but these terms are used for convenience to facilitate understanding of the embodiments. These terms are not limited to front, back, left, right, top, bottom, etc., in a geometrically strict sense unless expressly stated otherwise.

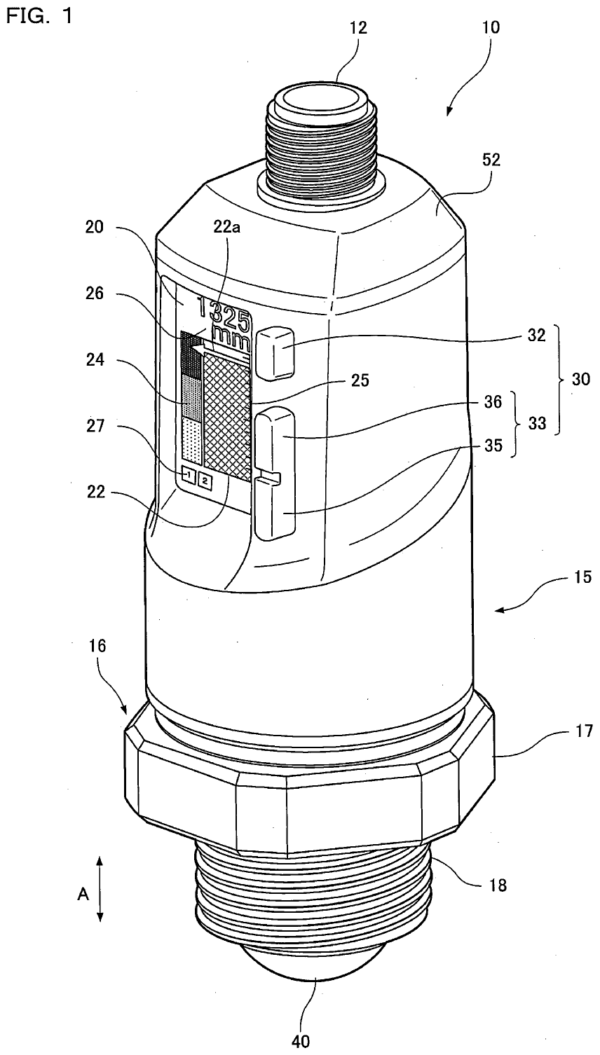

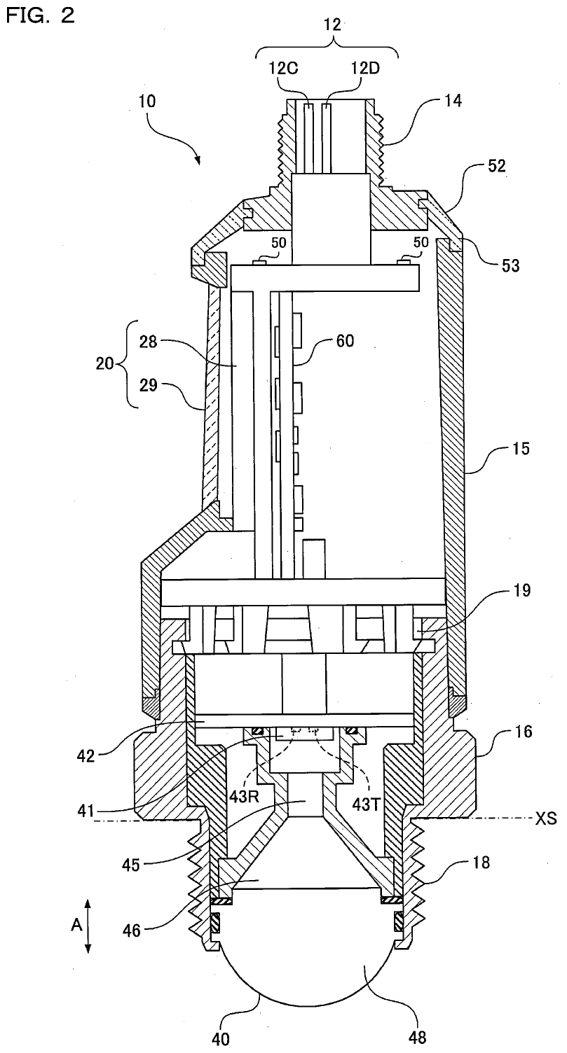

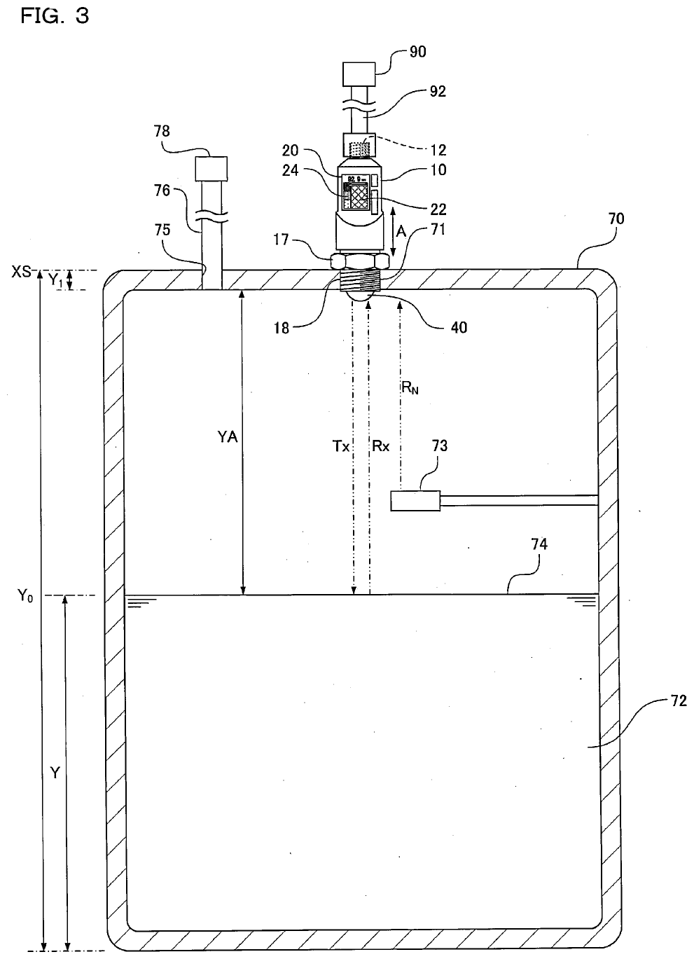

Hereinafter, a level meter 10 as an example of an embodiment according to the present invention will be described with reference to the drawings. First, an example of a structure and a use state of the level meter 10 will be described with reference to FIGS. 1, 2, and 3. In FIG. 1, a perspective view of the level meter 10 of the present embodiment is illustrated. FIG. 2 illustrates a cross-sectional view of the level meter 10 of FIG. 1. FIG. 3 illustrates a state in which the level meter 10 is attached to a container 70 (for example, a tank) that stores an object 72.

The level meter 10 is a device that measures a level Y of the object 72 to be measured (for example, liquid, powder, granular material, and the like). The measured level Y is the height of an interface 74 of the object 72 in the container 70. Specific examples of the level Y include the distance from the bottom of the container 70 to the liquid level of the liquid contained in the container 70. A measurement axis is set in the level meter 10, and the level meter 10 measures the level Y along the measurement axis.

As an example of the use state of the level meter 10, the container 70 of FIG. 3 stores, for example, a liquid (water, oil, chemical solution, and the like) as the object 72 in a liquid treatment facility. For example, when the object 72 in the container 70 is supplied to a liquid treatment process or the like, the level Y of the object 72 in the container 70 decreases. In addition, as the container 70 is replenished with the object 72, the level Y of the object 72 in the container 70 increases. For example, a water injection port 75 is provided in an outer wall (an upper wall in FIG. 3) of the container 70. A water injection pipe 76 is fluidly connected to the container 70 via the water injection port 75. Then, the water injection pipe 76 is connected to a water injection device 78 (device including, for example, a pump, a valve or the like) provided outside the container 70. The water injection device 78 is a device for supplying (injecting) the object 72 into the container 70 from the outside of the container 70. The water injection device 78 adjusts the amount of water injected into the container 70 according to the level Y of the object 72 in the container 70. In addition, the water injection device 78 stops the water injection depending on the level Y of the object 72 in the container 70. The water injection device 78 controls the replenishment of the object 72 to the container 70 according to the level Y of the object 72 in the container 70 such that the level Y of the object 72 in the container 70, which decreases as the object 72 is consumed, for example, by the liquid treatment process, falls within a predetermined range.

The level meter 10 of FIG. 1 has a generally cylindrical shape extending in the longitudinal direction A (direction of the measurement axis). The level meter 10 includes a housing 15 and a sensor unit 16, and the housing 15 and the sensor unit 16 are arranged along the longitudinal direction A. The sensor unit 16 is disposed on one end side (lower side in FIG. 1) of the level meter 10 in the longitudinal direction A, and the housing 15 is disposed on the other end side (upper side in FIG. 1) in the longitudinal direction A. Hereinafter, one end (lower end) of the sensor unit 16 in the longitudinal direction A is referred to as a measurement end 40. As illustrated in FIG. 2, a dielectric lens 48 is disposed at the measurement end 40. Hereinafter, one end side of the level meter 10 in the longitudinal direction A may be referred to as a lower side, and the other end side in the longitudinal direction A may be referred to as an upper side.

As illustrated in FIG. 3, the level meter 10 in FIG. 1 measures the level Y of the object 72 with the measurement end 40 directed toward the object 72. For example, in a case where the level meter 10 measures the height (interface 74) of the liquid, the longitudinal direction A of the level meter 10 faces the same direction as the change direction of the height of the liquid level of the liquid, that is, the vertical direction (height direction, gravitation direction).

The level meter 10 in FIG. 3 transmits a radio wave to be the measurement signal Tx from the measurement end 40 toward the object 72. Then, a reflection signal Rx obtained by reflecting the measurement signal Tx at the interface 74 of the object 72 is received by the measurement end 40. The level meter 10 calculates the level Y of the object 72 based on the measurement signal Tx and the reflection signal Rx. For example, in the case of performing the measurement using the time of flight (ToF) method, the level meter 10 calculates a distance YA from the measurement end 40 to the interface 74 based on the difference between the measurement signal Tx and the reflection signal Rx, and calculates the level Y based on the distance YA. In addition, for example, in a case where measurement is performed by a radar method using a frequency modulated continuous wave (FMCW), the level meter 10 calculates the distance YA from the measurement end 40 to the interface 74 based on a frequency of a waveform obtained by mixing the measurement signal Tx and the reflection signal Rx, and calculates the level Y based on the distance YA.

As illustrated in FIG. 1, an attachment screw 18 in which a thread is engraved on the surface of the cylinder is provided above the measurement end 40 in the sensor unit 16. An attachment portion 17 having a diameter larger than that of the attachment screw 18 is provided above the attachment screw 18. The attachment portion 17 in FIG. 1 has a nut shape. Note that the attachment portion 17 is not limited to a nut shape as long as it has a structure capable of attaching the level meter 10 to an attachment target (such as a container 70 that stores liquid). For example, the attachment portion 17 may have a cylindrical shape in which an anti-slip projection is formed. The anti-slip projection of the attachment portion 17 serves as an anti-slip portion when the level meter 10 is attached or detached (rotationally attached or detached) while rotating around the longitudinal direction A with respect to the attachment target. In addition, an attachment flange for attaching the level meter 10 to an attachment target may be formed instead of the attachment portion 17 and the attachment screw 18. In addition, even in a case where the attachment flange is formed, the attachment portion 17 and the attachment screw 18 may be provided in addition to the attachment flange.

The level meter 10 in FIG. 3 is attached to the upper side of the container 70. An attachment hole 71 is provided above the container 70. The attachment hole 71 is a screw hole, and the attachment screw 18 of the level meter 10 is screwed into the attachment hole 71, whereby the level meter 10 is attached to the container 70. For example, the user of the level meter 10 can screw the attachment screw 18 into the attachment hole 71 by rotating the nut-shaped attachment portion 17 with the leading end of the attachment screw 18 aligned with the attachment hole 71. Note that the structure for attaching the level meter 10 to the container 70 is not limited thereto. For example, the attachment hole 71 is not threaded, and a nut is separately screwed to the attachment screw 18 exposed to the inside of the container 70, whereby the level meter 10 may be attached to the container 70. In addition, the level meter 10 may be attached to a mounting bracket which is provided above the container 70 with an upper surface of the container 70 opened by using a nut and the attachment screw 18. In addition, the method of attaching the level meter 10 to the container 70 is not limited to the screwing using the attachment screw 18, and the thread may not be formed on the outer peripheral surface of the sensor unit 16. For example, a flange may be provided on one or both of the level meter 10 and the container 70, and the level meter 10 may be attached to the container 70 by fixing the flange to the level meter 10 or the container 70 with a bolt.

The housing 15 disposed above the sensor unit 16 is provided with a display portion 20. The display portion 20 is disposed on an outer peripheral surface of the housing 15 extending along the longitudinal direction A. The display portion 20 preferably includes an active matrix type display device (active matrix display) capable of displaying various types of information. For example, the display portion 20 includes a liquid crystal display (LCD). In particular, the display portion 20 preferably includes an LCD capable of color display (display with a plurality of colors).

The display portion 20 may be a two-wire reflective color liquid crystal display that performs both power transmission and reception and data communication by two power lines. The two-wire display performs data communication by varying the magnitude of the current transmitted through the power line. For example, the consumption current of the power line varies in the range of 4 to 20 mA. The content of the data to be transmitted and received is represented by the magnitude of the consumption current. In addition, the reflective display allows the user to visually recognize the display content by external light reflected on the surface thereof. Although a two-wire display can use small power consumption, a two-wire reflective color liquid crystal display can perform various displays with small power consumption.

The display portion 20 displays the level Y of the object 72 measured by the sensor unit 16. In FIGS. 1 and 3, a bar display 22 whose length expands and contracts according to the value of the level Y is displayed on the display portion 20. In addition, the display portion 20 also displays a color gauge 24 (example of a gauge) color-coded with a plurality of colors. The length direction of the color gauge 24 is arranged along the expansion/contraction direction of the bar display 22. The color gauge 24 includes a plurality of (three in FIG. 1) sections arranged along the expansion/contraction direction of the bar display 22. The section of the color gauge 24 corresponds to a plurality of level ranges set with respect to the level Y of the object 72, and the level range is defined by a plurality of level setting values (for example, thresholds) set with respect to the level Y.

The display portion 20 displays the relative position of the level Y with respect to the container 70 storing the object 72 together with the bar display 22. Specifically, the bar display 22 expands and contracts in length according to the value of the level Y of the object 72 in a container icon 25 imitating the container 70. The length of the bar display 22 with respect to the size of the container icon 25 corresponds to the relative position of the level Y of the object 72 with respect to the entire container 70.

Then, a bar arrow 22a is displayed at a leading end (upper end) in the expansion/contraction direction of the bar display 22. The bar arrow 22a indicates a position in the color gauge 24 corresponding to the length of the bar display 22. The color gauge 24 indicates to which level range the measured level Y belongs among the plurality of level ranges defined by the level setting value.

The color gauge 24 includes a plurality of sections. The plurality of sections of the color gauge 24 are divided into a plurality of level ranges. Then, the plurality of sections of the color gauge 24 are arranged along the increasing/decreasing direction of the level Y in the display portion 20. The container icon 25 and the bar display 22 are displayed next to the color gauge 24 (side by side with the color gauge 24). Since the color gauge 24 is displayed side by side with the container icon 25 and the bar display 22 in the display portion 20, the relative position of the level setting value with respect to the container 70 is displayed together with the bar display 22.

In addition, an auxiliary display portion 26 indicating information other than the bar display 22 and the color gauge 24 is also displayed on the display portion 20. In FIG. 1, a numerical value (mm, millimeter value) of the measured level Y is displayed on the auxiliary display portion 26.

In addition, the display portion 20 also displays an output state display portion 27. The output state display portion 27 displays the state of the signal line whose output changes depending on the relationship between the measured level Y and the level setting value. For example, when a signal is transmitted from a specific signal line in a case where the level Y exceeds a threshold determined as a level setting value, a number corresponding to the signal line is displayed in the output state display portion 27. For example, in FIG. 1, the bar arrow 22a indicates the uppermost section among the three sections of the color gauge 24. This state of the display portion 20 indicates that two thresholds are set as the level setting value, and the measured level Y exceeds both of the two thresholds.

Then, when a signal line that outputs a signal in a case where the measured level Y exceeds the threshold is prepared, signals are output from two signal lines corresponding to the two thresholds in the state of FIG. 1. In FIG. 1, in order to indicate that signals are output from two signal lines, numbers (here, “1” and “2”) corresponding to the two signal lines that output signals are displayed on the output state display portion 27.

In addition, an operation unit 30 is also disposed in the same surface as the outer surface of the housing 15 where the display portion 20 is disposed. The operation unit 30 of FIG. 1 is disposed adjacent to the display portion 20 and includes a menu key 32 and a direction key 33 arranged along the longitudinal direction A. In addition, the direction key 33 includes an up key 36 and a down key 35 arranged along the longitudinal direction A.

A connection portion 12 is provided on the upper side of the housing 15. The connection portion 12 in FIG. 1 has a cylindrical shape extending in the longitudinal direction A. An outer peripheral surface of the cylindrical connection portion 12 is a connection screw portion 14 in which a thread is cut. As illustrated in FIG. 2, the connection portion 12 includes an external input terminal 12C and an external output terminal 12D. The external input terminal 12C is a terminal for inputting a signal or power, or both, from the outside to the level meter 10. The external output terminal 12D is a terminal for outputting a signal from the level meter 10 to the outside. Each of the external input terminal 12C and the external output terminal 12D may include a plurality of signal lines or a plurality of terminals. For example, signals may be output from different signal lines or different output terminals to the outside according to the level range to which the measured level Y belongs.

A connection cable 92 illustrated in FIG. 3 is connected to the connection portion 12. The connection cable 92 connects a management device 90 (such as a programmable controller) provided outside the container 70 and the level meter 10. A signal indicating the level Y of the object 72 measured by the level meter 10 is transmitted (output) to the management device 90 through the external output terminal 12D (a part of output unit 66 to be described later) of the connection portion 12 and the connection cable 92. The management device 90 manages the operation of the entire facility including the container 70 based on the signal received from the level meter 10.

In addition, a status lamp 52 is provided between the connection portion 12 and the display portion 20 so as to surround the lower side (root) of the connection portion 12. The lighting state of the status lamp 52 changes according to the measured level Y of the object. The user can roughly know the state of the object by visually observing the lighting state of the status lamp 52. The status lamp 52 can emit light in various lighting colors (for example, green, yellow, red, and the like). The status lamp 52 preferably emits light in a lighting color corresponding to the level range to which the level Y measured by the level meter 10 belongs. For example, the status lamp 52 may emit light in the same color as the color of the section indicated by the bar arrow 22a among the color gauges 24 color-coded by a plurality of colors for each section.

As illustrated in the cross-sectional view of FIG. 2, a sensor IC 41 (IC: Integrated Circuit) and a sensor board 42 that supports the sensor IC 41 are disposed inside the sensor unit 16. The sensor IC 41 performs transmission and reception of radio waves and signal processing for measuring the level Y of the object 72. The signal processed by the sensor IC 41 is transmitted to a display board 60 provided in the terminal 21.

As the sensor IC 41, for example, an MMIC (Monolithic Microwave Integrated Circuit) is used. The MMIC is an IC in which a plurality of semiconductor components that perform transmission of radio waves, reception of radio waves, signal processing based on transmitted and received radio waves, and the like are integrated into a single semiconductor device (one chip). In the sensor IC 41 of FIG. 2, an antenna is integrated with the MMIC by using an antenna in package (AiP) technology or an antenna on package (AoP) technology. That is, in FIG. 2, the sensor IC 41 is an antenna-integrated package (antenna on package) in which a transmission circuit 43T that transmits a radio wave and a reception circuit 43R that receives a radio wave are integrated in a single semiconductor device. Since the antenna-integrated MMIC is used as the sensor IC 41, the volume occupied by the configuration for transmitting and receiving radio waves is reduced, and the entire dimension of the level meter 10 becomes compact. Note that the sensor IC 41 is not limited to the antenna-integrated MMIC alone, and may include a plurality of ICs. The sensor IC 41 may include, for example, an MMIC and a microcomputer. Then, the antenna-integrated MMIC may include a radio wave transmission antenna, a radio wave reception antenna, and a circuit that executes radio wave transmission/reception control, and the microcomputer may include a circuit that executes signal processing or arithmetic processing based on a reception signal received from the antenna-integrated MMIC.

The sensor IC 41 is mounted on the lower surface of the sensor board 42. The sensor board 42 is an electronic circuit board in which various electronic circuit elements are arranged on a plate made of an insulator such as glass or resin. In FIG. 2, the sensor board 42 is disposed in a direction orthogonal to the longitudinal direction A (horizontal direction in FIG. 2).

The measurement end 40 is located below the sensor board 42. The measurement end 40 of FIG. 2 includes a waveguide 45, a horn antenna 46, and a dielectric lens 48 as internal structures. In a case where the sensor IC 41 is an antenna-integrated MMIC, a radio wave serving as the measurement signal Tx is transmitted from the transmission circuit 43T of the sensor IC 41. The measurement signal Tx transmitted from the sensor IC 41 is guided toward the object 72 through the waveguide 45, the horn antenna 46, and the dielectric lens 48 in this order. In addition, the reflection signal Rx reflected by the object 72 and incident on the measurement end 40 is guided toward the reception circuit 43R of the sensor IC 41 through the dielectric lens 48, the horn antenna 46, and the waveguide 45 in this order.

The waveguide 45, the horn antenna 46, and the dielectric lens 48 arranged inside the sensor unit 16 guide the traveling direction of the radio wave the radio wave in the longitudinal direction A, and thus they exhibit strong directivity with respect to the radio wave as a whole by combining them. Therefore, the sensor unit 16 can appropriately guide the measurement signal Tx and the reflection signal Rx even if the length direction dimension (length along the longitudinal direction A) is small. In addition, by appropriately guiding the measurement signal Tx and the reflection signal Rx, the transmission of the measurement signal Tx and the reception of the reflection signal Rx can be performed by the common measurement end 40 even though the position of the transmission circuit 43T and the position of the reception circuit 43R are different in the sensor IC 41. Therefore, by using the waveguide 45, the horn antenna 46, and the dielectric lens 48, the designer of the level meter 10 can reduce the dimension in the length direction of the level meter 10 including the sensor unit 16, and the dimension of the entire level meter 10 can be made compact.

On the other hand, in the housing 15, a rotation mechanism 19 is provided on the upper side of the sensor board 42. The rotation mechanism 19 in FIG. 2 is disposed at a lower end (one end in the longitudinal direction A) of the housing 15, that is, between the housing 15 and the sensor unit 16. The rotation mechanism 19 can relatively rotate the housing 15 with respect to the sensor unit 16. The rotation mechanism 19 is disposed such that the rotation axis is parallel to the longitudinal direction A. Since the rotation mechanism 19 is provided, the user can turn the display portion 20 in a direction in which it is easy to view by rotating the housing 15. In particular, when the level meter 10 is attached to the container 70 (such as a tank) including the object 72 by the attachment screw 18, the user can direct the display portion 20 in a direction in which the user can easily see the display portion 20 without moving the entire level meter 10.

In the housing 15, the display board 60 is disposed above the rotation mechanism 19. The display board 60 is an electronic circuit board in which various electronic circuit elements are arranged on a plate made of an insulator such as glass or resin. A signal processing circuit for controlling the display portion 20 is mounted on the display board 60. The display board 60 receives a signal from the sensor IC 41, and converts the level Y of the object 72 measured by the sensor unit 16 into a signal for displaying the level in the display portion 20. The display board 60 of FIG. 2 is disposed on the back side of the display portion 20 (inside the housing 15 in FIG. 2).

The display portion 20 in FIG. 2 includes a display device 28 and a transparent display window 29. The display device 28 is, for example, an LCD, particularly an LCD capable of color display. The display window 29 is, for example, a plate made of an optically transparent material such as glass, acrylic, polyarylate, or polycarbonate, and optically transmits the display content of the display device 28 to the outside of the housing 15.

The status lamp 52 disposed between the display portion 20 and the connection portion 12 includes a plurality of state LEDs 50 (Light Emitting Diodes (LEDs)) and a transmission window 53. The plurality of state LEDs 50 are disposed above the display board 60 and the display portion 20. The lighting state of the state LED 50 changes according to the level of the object measured by the sensor unit 16. In addition, a transmission window 53 including a member (such as a light diffusion film) that diffuses light is disposed above the state LED 50. The light emitted from the state LED 50 is guided to the outside of the housing 15 through the transmission window 53. Therefore, as the lighting state of the state LED 50 changes according to the level Y of the object, the lighting state of the status lamp 52 changes. In addition, since the transmission window 53 includes a member that diffuses light, the light emitted from the state LED 50 is uniformly diffused in all directions around the connection portion 12.

The lighting state of the state LED 50 changes according to the level Y of the object 72 measured by the sensor unit 16. The light emitted from the state LED 50 is guided to the outside of the housing 15 through the transmission window 53. Therefore, as the lighting state of the state LED 50 changes according to the level Y of the object 72, the lighting state of the status lamp 52 changes. In addition, since the transmission window 53 includes a member that diffuses light, the light emitted from the state LED 50 is diffused in a direction intersecting the longitudinal direction A. Therefore, the user can easily visually grasp the lighting state of the status lamp 52 from a long distance.

The state LED 50 may emit light in a single color (for example, red, yellow, green, and the like) or may emit light by switching a plurality of colors (for example, red, yellow, green, and the like). When the state LED 50 emits light by switching a plurality of colors, a plurality of light emitting elements that emit light in different colors may be included in one LED, or a combination of a plurality of LEDs that emit light in different colors may be arranged as the state LED 50. Then, the state LED 50 may emit light by mixing a plurality of colors. In addition, when the state LED 50 emits light by switching a plurality of colors, the state LED 50 may emit light in a color corresponding to the color of the section of the color gauge 24 corresponding to the level range to which the measured level Y belongs.

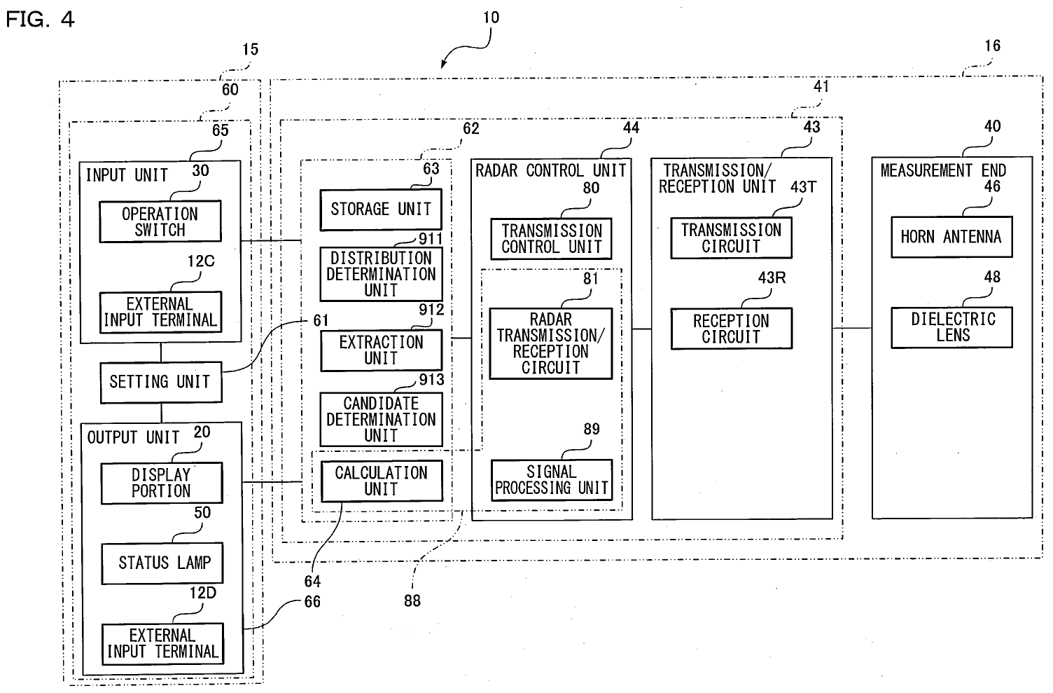

Next, a relationship between the components of the level meter 10 will be described with reference to FIG. 4. FIG. 4 is a block diagram schematically illustrating an example of a relationship between the components of the level meter 10. As illustrated in FIG. 4, the sensor IC 41 of the sensor unit 16 includes a transmission/reception unit 43, a radar control unit 44, and a processing unit 62. The transmission/reception unit 43 includes a transmission circuit 43T that transmits the measurement signal Tx and a reception circuit 43R that receives the reflection signal Rx. The sensor IC 41 may include a plurality of ICs. For example, the sensor IC 41 may include an antenna-integrated MMIC and a microcomputer.

The radar control unit 44 includes a transmission control unit 80 that determines the waveform of the measurement signal Tx, a radar transmission/reception circuit 81 that performs mutual conversion between a digital signal and a radio wave, and a signal processing unit 89 that performs signal processing based on the measurement signal Tx and the reflection signal Rx. Further, in a case where the sensor IC 41 includes the antenna-integrated MMIC and the microcomputer, the antenna-integrated MMIC may include a portion (the transmission control unit 80 and the radar transmission/reception circuit 81) of the radar control unit 44 excluding the signal processing unit 89 and the transmission/reception unit 43, and the microcomputer may include the signal processing unit 89 and the processing unit 62.

The processing unit 62 includes a storage unit 63, a calculation unit 64, a distribution determination unit 911, an extraction unit 912, and a candidate determination unit 913. The storage unit 63 stores various setting values (data) related to the operation of the level meter 10. The calculation unit 64 performs various calculations relating to the operation of the level meter 10 based on the setting values stored in the storage unit 63, the signal processing result of the signal processing unit 89, and the like. The storage unit 63 includes a storage device such as a random access memory (RAM) and a read only memory (ROM). The calculation unit 64 includes a processor such as a central processing unit (CPU). Note that the storage unit 63 and the calculation unit 64 may be provided on the display board 60 of the housing 15. Alternatively, the storage units 63 and the calculation units 64 may be separately provided in the sensor unit 16 and the housing 15, respectively, and stored data and responsible arithmetic processing may be shared by the sensor unit 16 and the housing 15. In addition, as illustrated in FIG. 4, the calculation unit 64, the radar transmission/reception circuit 81 of the radar control unit 44, and the signal processing unit 89 together function as a measurement value determination unit 88. The measurement value determination unit 88 performs processing of determining a measurement value related to the distance or the level Y from the level meter 10 of the object 72 on the basis of the reflection signal Rx received by the reception circuit 43R and the container information (for example, the height of the container 70) related to the container 70.

The distribution determination unit 911 determines the reception intensity distribution of the reflection signal Rx with respect to the distance from the level meter 10 based on the reception intensity of the reflection signal Rx received by the reception circuit 43R. The extraction unit 912 extracts the peak position and the peak intensity from the reception intensity distribution determined by the distribution determination unit 911. The candidate determination unit 913 causes the extraction unit 912 to extract a plurality of combinations of peak positions and peak intensities from the reception intensity distribution determined by the distribution determination unit 911, and determines the combinations as a plurality of peak candidates.

On the other hand, the display board 60 of the housing 15 includes a setting unit 61, an input unit 65, and an output unit 66. The setting unit 61 performs processing of sequentially setting the container information regarding the container 70 and a plurality of level setting values regarding the level Y. The input unit 65 is an interface circuit that inputs an input provided from the outside of the level meter 10 to the level meter 10 as a signal. The input provided from the outside of the level meter 10 is, for example, a user's operation on the operation unit 30, a control signal provided from an external device (such as the management device 90 or the like) via the external input terminal 12C, and the like. The input unit 65 causes the storage unit 63 to store, for example, flag information indicating that the operation unit 30 has been operated, and data such as a setting value provided via the external input terminal 12C.

The output unit 66 is an interface circuit that outputs a signal generated inside the level meter 10 to the outside. The output unit 66 changes, for example, the display content of the display portion 20, the lighting state of the status lamp 52, and the like according to the calculation result (such as the value of the level Y) by the calculation unit 64. In addition, the output unit 66 transmits the calculation result by the calculation unit 64 to an external device via the external output terminal 12D.

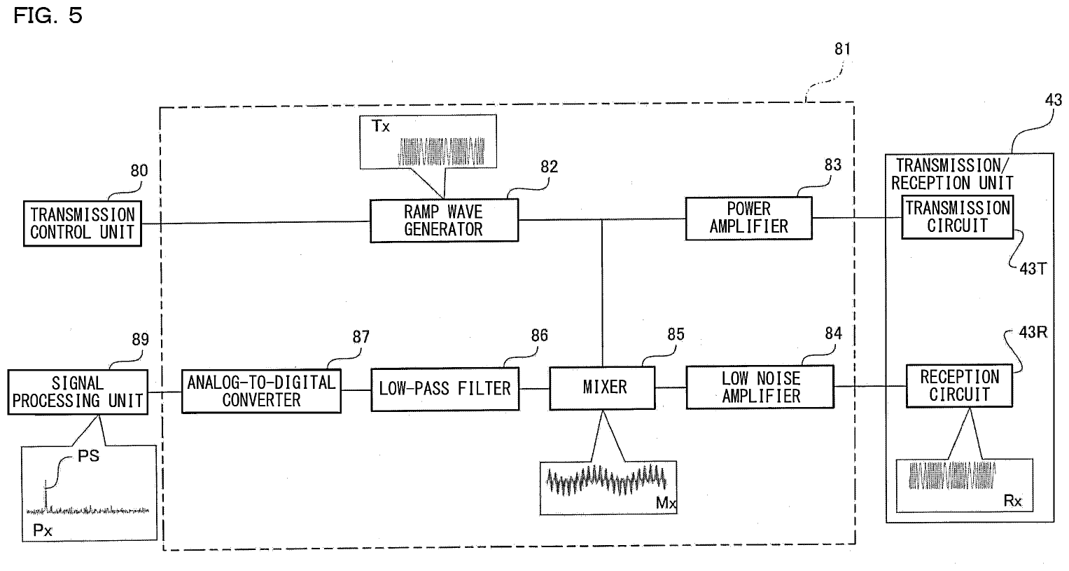

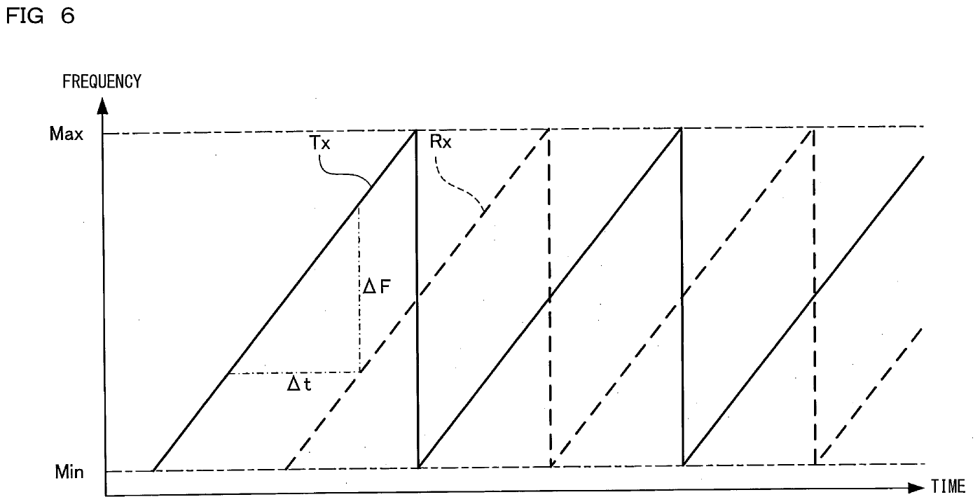

The measurement of the level Y by the level meter 10 will be described in more detail with reference to FIGS. 5 and 6. FIG. 5 is a view illustrating an example of configurations of the radar transmission/reception circuit 81 and the transmission/reception unit 43 included in the sensor IC 41. FIG. 6 is a view illustrating a relationship between the measurement signal Tx and the reflection signal Rx.

As illustrated in FIG. 5, the radar transmission/reception circuit 81 includes a ramp wave generator 82, a power amplifier 83, a low noise amplifier 84, a mixer 85, a low-pass filter 86, and an analog-to-digital converter 87.

The level meter 10 of the present embodiment measures the level Y by a radar method using FMCW. The ramp wave generator 82 is connected to the transmission control unit 80. When receiving data indicating the waveform of the measurement signal Tx determined by the transmission control unit 80, the ramp wave generator 82 generates a signal having the waveform according to the data. Here, as the waveform of the measurement signal Tx, a waveform that repeats increase and decrease in frequency is used.

FIG. 6 is a graph illustrating a change in frequency of the measurement signal Tx (and the reflection signal Rx) with respect to time. In FIG. 6, the frequency of the measurement signal Tx increases linearly with time from a minimum value (Min), and returns to the minimum value again when reaching a maximum value (Max). In this manner, the frequency of the measurement signal Tx repeatedly increases and decreases. Note that the frequency increase/decrease pattern is not limited to this, and it is sufficient that the measurement value determination unit 88 can calculate the level Y on the basis of the comparison between the measurement signal Tx and the reflection signal Rx. For example, a pattern that decreases linearly from the maximum value with time and returns to the maximum value again when reaching the minimum value may be used. In addition, a pattern of repeating linear increase/decrease and decrease between the maximum value and the minimum value may be used. The measurement signal Tx used in the present embodiment is a radio wave in the 60 GHz band, and the minimum value of the frequency is, for example, 58 GHz and the maximum value is, for example, 69 GHz. The frequency band to be used is not limited thereto, and for example, a frequency of 77 GHz to 81 GHz may be used.

The signal generated by the ramp wave generator 82 in FIG. 5 is amplified by the power amplifier 83 and sent to the transmission circuit 43T. The transmission circuit 43T generates a radio wave having a waveform corresponding to the received signal and transmits the radio wave as the measurement signal Tx to the object 72. The measurement signal Tx is reflected by the interface 74 of the object 72 to become the reflection signal Rx, and is received as a reception signal by the reception circuit 43R. The reflection signal Rx is a wave having a phase shifted from that of the measurement signal Tx.

As indicated by a broken line in FIG. 6, the reflection signal Rx is a wave shifted from the measurement signal Tx by a time difference Δt. The time difference Δt is a value corresponding to the distance YA (FIG. 3) from the measurement end 40 to the interface 74 of the object 72. Since the reflection signal Rx reciprocates between the measurement end 40 and the object 72, there is a relationship of Δt=2×YA/c where c is the speed of light.

Then, a frequency difference ΔF corresponding to the magnitude of the time difference Δt is generated between the measurement signal Tx and the reflection signal Rx. There is a certain relationship between the frequency difference ΔF and the time difference Δt depending on the waveform of the measurement signal Tx. The waveform of the measurement signal Tx is a waveform whose frequency linearly changes with the lapse of time. That is, there is a certain relationship between the frequency difference ΔF and the time difference Δt according to the frequency change per unit time in the waveform of the measurement signal Tx. For example, the frequency of the measurement signal Tx increases linearly from the minimum value (Min) as time elapses, and reaches the maximum value (Max). In this case, the relationship between the frequency difference ΔF and the time difference Δt is uniquely determined by the difference between the maximum value and the minimum value of the frequency of the measurement signal Tx, which is the bandwidth of frequency modulation, and the relationship of the frequency change with time. Therefore, the level meter 10 can calculate the time difference Δt based on the frequency difference ΔF that is a difference between the measurement signal Tx and the reflection signal Rx. Then, the level meter 10 can calculate (Δt×c/2). Further, the level meter 10 can calculate the value of the level Y based on the distance YA. Specifically, the difference between the height of the container 70 (distance from the bottom of the container 70 to the upper surface inside the container 70) and the distance YA is the value of the level Y. Therefore, the measurement value determination unit 88 can determine the level Y of the object 72 based on the reflection signal Rx received by the reception circuit 43R and the container information (such as the height of the container 70) on the container 70. Container information regarding the container 70, such as the height of the container 70, a bottom distance Y₀ from the level meter 10 to the bottom of the container 70, and an upper surface distance Y₁ from the level meter 10 to the upper surface of the inside of the container 70 (the thickness of the top plate of the container 70 in FIG. 3), may be set in advance by the setting unit 61 before the measurement of the level Y is started. Note that the distance from the level meter 10 is, to be precise, a distance from a measurement reference surface XS (a plane on which the value of the distance is treated as 0) serving as a reference of measurement in the level meter 10. The position of the measurement reference surface XS is determined in advance before the use of the level meter 10 (for example, at the time of designing the level meter 10). For example, a position where the level meter 10 is attached to the container 70 (a position of an outer upper surface of the container 70 in FIG. 3) is determined as the measurement reference surface XS. In terms of the position in the level meter 10, the lower surface of the attachment portion 17 (the upper end of the attachment screw 18) is the measurement reference surface XS. In addition, since there is a certain relationship between the frequency difference ΔF and the time difference Δt depending on the waveform of the measurement signal Tx, the correspondence relationship between the frequency difference ΔF and the distance YA can be obtained in advance. The correspondence relationship between the frequency difference ΔF and the distance YA may be stored in advance in the storage unit 63.

As illustrated in FIG. 5, the reception signal corresponding to the reflection signal Rx received by the reception circuit 43R is input to the mixer 85 via the low noise amplifier 84. A signal corresponding to the waveform of the measurement signal Tx output from the ramp wave generator 82 is also input to the mixer 85, and the mixer 85 generates a mixed signal Mx obtained by mixing the waveforms of the measurement signal Tx and the reflection signal Rx. Specifically, the mixer 85 included in the radar transmission/reception circuit 81 functioning as a part of the measurement value determination unit 88 mixes the measurement signal Tx and the reflection signal Rx to generate an IF signal (IF: intermediate frequency) as the mixed signal Mx.

The IF signal (intermediate frequency signal) has a waveform including a high frequency component derived from the frequency of the 60 GHz band of the measurement signal Tx and the reflection signal Rx and a low frequency component corresponding to the frequency difference ΔF between the measurement signal Tx and the reflection signal Rx. The IF signal is input to the low-pass filter 86, and a low-frequency waveform according to the frequency difference ΔF is extracted. The extracted low-frequency waveform is input to the analog-to-digital converter 87. The analog-to-digital converter 87 converts a low-frequency waveform into a digital value and outputs the digital value to the signal processing unit 89.

The signal processing unit 89 that functions as a part of the measurement value determination unit 88 converts the low-frequency waveform output from the analog-to-digital converter 87 into a frequency signal Px by fast Fourier transform processing or the like. The frequency signal Px is a signal indicating the strength of the wave for each frequency, and a target peak PS derived from the reflection signal Rx due to reflection of the measurement signal Tx at the interface 74 appears in the frequency signal Px. The frequency corresponding to the target peak PS is the frequency difference ΔF between the measurement signal Tx and the reflection signal Rx. The signal processing unit 89 transmits the frequency signal Px to the calculation unit 64 in FIG. 4.

The calculation unit 64 functioning as a part of the measurement value determination unit 88 calculates the values of the distance YA and the level Y based on the frequency signal Px. In calculating the values of the distance YA and the level Y, the calculation unit 64 refers to the information stored in the storage unit 63. For example, the storage unit 63 stores a correspondence relationship between the frequency difference ΔF and the distance YA, a value (container information such as the height of the container 70) for calculating the level Y from the distance YA, and the like.

After calculating the frequency difference ΔF corresponding to the target peak PS of the frequency signal Px, the calculation unit 64 calculates the values of the distance YA and the level Y based on the frequency difference ΔF and the information stored in the storage unit 63. In this manner, the calculation unit 64 functioning as a part of the measurement value determination unit 88 determines the level Y of the object 72 based on the intermediate frequency signal. The calculation unit 64 transmits the calculated value of the level Y to the output unit 66. The output unit 66 changes the display content of the display portion 20 and the lighting state of the status lamp 52 according to the value of the level Y. In addition, the value of the level Y is sent to the management device 90 (FIG. 3) through the external output terminal 12D. The output unit 66 may output a binary or multi-valued control signal based on the comparison result between the calculated value of the level Y and the threshold to the management device 90 through the external output terminal 12D. In addition, instead of the value of the level Y itself, a signal indicating that specific control according to the state of the level Y is to be executed may be sent to the management device 90. For example, when the level Y is above a certain threshold or below a certain threshold, a signal indicating that the operation of the pump, valve or the like should be changed may be sent to the management device 90.

Further, depending on the measurement environment, a peak other than the target peak PS as illustrated in FIG. 5 may appear in the frequency signal Px due to an element other than the interface 74 of the object 72. For example, as illustrated in FIG. 3, the measurement signal Tx may be reflected by the container built-in object 73 (stirrer, ladder, etc.) to generate an ambient signal R_{N} different from the reflection signal Rx from the interface 74. Then, in the frequency signal Px, a peak derived from the ambient signal R_{N} also appears in addition to the target peak PS. Therefore, a plurality of peaks are generated in the frequency signal Px.

In such a case, the calculation unit 64, the radar transmission/reception circuit 81, and the signal processing unit 89 that function as the measurement value determination unit 88 can determine the measurement value of the distance corresponding to each of the plurality of generated peaks. The measurement value of the distance corresponding to the peak represents how far the peak is derived from the signal reflected from the level meter 10. The distribution determination unit 911 can use the correspondence relationship between the frequency difference ΔF between the measurement signal Tx and the reflection signal Rx (including the ambient signal R_{N}) and the distance YA to determine the reception intensity distribution indicating the relationship between the intensity of the signal received by the level meter 10 and the distance from the level meter 10 at which the signal is reflected.

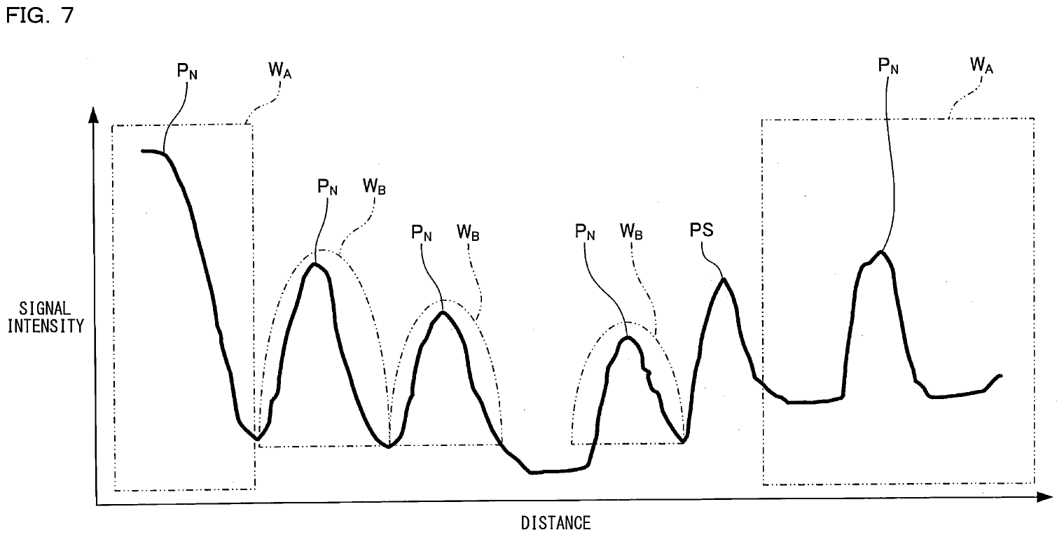

FIG. 7 illustrates an example of the reception intensity distribution as a graph. In the graph of FIG. 7, a plurality of peak candidates (peaks that may be the target peak PS derived from the interface 74 of the object 72) appear. The ambient peak P_{N}, which is a peak candidate other than the target peak PS, is derived from the ambient signal R_{N} reflected at a portion other than the interface 74 of the object 72.

The extraction unit 912 extracts the peak position and the peak intensity of each peak from the reception intensity distribution determined by the distribution determination unit 911. The peak position corresponds to the distance from the level meter 10 of the element (for example, the interface 74 of the object 72, the container built-in object 73, and the like) reflecting the measurement signal Tx in the container 70. In addition, the peak intensity corresponds to the intensity of the reflection signal Rx due to reflection of the measurement signal Tx. Further, hereinafter, the reflection signal Rx reflected by the interface 74 and the ambient signal R_{N} reflected by the container built-in object 73 or the like may be collectively referred to as a reflection signal Rx.

The candidate determination unit 913 extracts a plurality of combinations of the peak position and the peak intensity and determines the combinations as a plurality of peak candidates. The peak candidate includes a target peak PS derived from the interface 74 of the object 72 and an ambient peak P_{N} derived from the container built-in object 73 or the like. Then, a plurality of peak candidates determined by the candidate determination unit 913 based on the reception intensity distribution is displayed on the display portion 20. The user selects the target peak PS corresponding to the position (distance from the level meter 10) of the interface 74 of the object 72 from the plurality of peak candidates.

By appropriately performing calculation, the measurement value determination unit 88 can remove peak candidates other than the target peak PS from the reception intensity distribution and determine the distance YA or the level Y of the storage object 72 based on the target peak PS. For example, the measurement value determination unit 88 can remove peak candidates other than the target peak PS from the reception intensity distribution by performing mask processing and background processing on the reception intensity distribution. By removing peak candidates other than the target peak PS from the reception intensity distribution, the measurement value determination unit 88 can determine the measurement value of the object 72 based only on the target peak PS. Then, the measurement value determination unit 88 can correctly determine the measurement value of the object 72 even in an environment where the measurement signal Tx is reflected by an element (such as the container built-in object 73) other than the object 72 and the ambient signal R_{N} is generated. In addition, the user does not need to be aware of a complicated waveform based on the measurement signal Tx, the reflection signal Rx, the ambient signal R_{N}, and the like when removing unnecessary information such as the ambient peak P_{N}. Therefore, the user can complete the setting of the measurement condition necessary for the measurement of the level Y with a simple operation of selecting the target peak PS from the given options.

### (Mask Processing)

For example, a peak occurring at a position at a large distance from the level meter 10 (the ambient peak P_{N} at the right end in the drawing) may be derived from a signal reflected at the bottom of the container 70. In order to remove the peak derived from the signal reflected at the bottom of the container 70, a signal generated at a position where the distance from the level meter 10 is close to the distance to the bottom may be ignored.

In addition, a peak occurring at a position at a small distance from the level meter 10 (the ambient peak P_{N} at the left end in the drawing) may be derived from internal reflection at a near distance of the level meter 10. In order to remove a peak derived from internal reflection at a near distance, a signal emitted at a position at a small distance from the level meter 10 may be ignored.

Therefore, for example, as illustrated in FIG. 7, a region having a large distance and a region having a small distance from the level meter 10 in the reception intensity distribution may be set as a mask region W_{A}. When determining the measurement value related to the object 72, the measurement value determination unit 88 ignores the signal in the mask region W_{A} (does not treat the signal as a valid signal). The data on how much distance to set as the mask region W_{A} can be calculated in advance based on, for example, data on the installation environment of the level meter 10 (the height dimension of the container 70, and the like).

### (Background Processing)

In addition, a container built-in object 73 is always present at a fixed position inside the container 70. Therefore, the ambient peak P_{N} derived from the ambient signal R_{N} reflected by the container built-in object 73 appears as a constant waveform regardless of the fluctuation of the level Y of the object 72 in the reception intensity distribution. Therefore, in order to remove the ambient peak P_{N} derived from the ambient signal R_{N}, the waveform data of the ambient peak P_{N} is determined as a background signal W_{B}, and the waveform data that matches or approximates the waveform data of the background signal W_{B} among the waveform data included in the reception intensity distribution may be ignored.

For example, by subtracting the waveform data of the background signal W_{B} from the waveform data of the reception intensity distribution determined by the distribution determination unit 911, data in which the ambient peak P_{N} is removed from the reception intensity distribution is obtained. When one of the peak candidates is specified as the target peak PS, the waveform data of the background signal W_{B} is obtained from the reception intensity distribution. For example, the level meter 10 causes the user to select the target peak PS from a plurality of peak candidates. The measurement value determination unit 88 may store waveform data other than the selected target peak PS among the peak candidates appearing in the reception intensity distribution in the storage unit 63 as waveform data of the background signal W_{B}. Note that the level meter 10 can also obtain waveform data of the background signal W_{B} by performing measurement in advance in a state where there is no object 72 (in a state where the container 70 is empty).

### (Tracking Processing)

Further, in a case where the mask processing or the background processing is performed, the position of the target peak PS may enter the mask region W_{A}, or the waveform of the target peak PS may approximate the waveform of the background signal W_{B}. Even in such a case, tracking processing of the target peak PS is preferably performed so that the measurement value determination unit 88 can determine the measurement value of the object 72.

The level Y of the object 72 changes continuously in the container 70, and is less likely to fluctuate rapidly. Therefore, even in a case where the position of the target peak PS enters the mask region W_{A} or the waveform of the target peak PS becomes approximate to the waveform of the background signal W_{B}, if the value of the level Y has been measured until immediately before, the current level Y is expected to be close to the immediately preceding measurement value. Therefore, when the target peak PS is lost during the measurement, the measurement value determination unit 88 performs the measurement by estimating that the target peak PS is near the lost position (distance from the level meter 10) by the tracking processing. For example, the measurement value determination unit 88 may estimate the current position of the target peak PS according to the position immediately before the target peak PS is lost and the temporal change rate of the target peak PS until immediately before the target peak PS. Then, as a result of the target peak PS continuing to fluctuate, when the target peak PS passes through the mask region W_{A} and the background signal W_{B}, a new peak occurs near the position of the estimated target peak PS, and thus, the measurement value determination unit 88 may execute measurement with the new peak as the target peak PS.

It is preferable that the user can set how long the tracking processing is performed when the measurement value determination unit 88 loses the target peak PS during the measurement and how long the estimation position of the target peak PS is continuously estimated. Since there is a case where the target peak PS is fixed in the mask region W_{A} and the region of the background signal W_{B} (the level Y maintains a constant value), the tracking processing may be set so as not to be released with the lapse of time.

### (Intensity Priority and Near-Distance Priority)

In addition, in a case where there are a plurality of peaks within the range of the distance from the level meter 10 at which the target peak PS is expected to be present, which peak is regarded as the target peak PS may be selected from several methods. For example, there are an intensity-prioritized method in which a signal having a high intensity (signal amplitude) is preferentially regarded as the target peak PS, and a near-distance priority method in which a peak at a position with a small distance (near distance) from the level meter 10 is regarded as the target peak PS. Basically, the intensity-prioritized method is preferably selected, but for example, in a case where the measurement signal Tx is reflected many times between the interface 74 and the inner wall of the container 70, peaks having high intensity derived from the interface 74 are generated at a plurality of positions. In that case, since it is considered that a peak at a near distance with a small distance corresponds to the first reflection at the interface 74, the peak at a near distance may be regarded as the target peak PS. It is preferable that the user can set which of the intensity priority and the near-distance priority is selected.

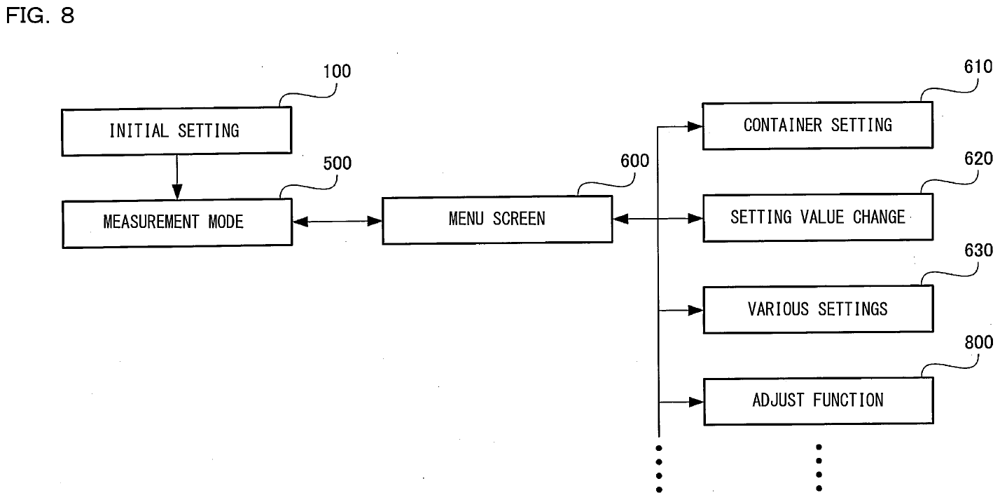

Next, the state transition of the level meter 10 will be described with reference to FIG. 8. First, when the level meter 10 is activated, initial setting 100 is started. In the initial setting 100, various setting screens for sequentially setting the operation conditions of the level meter 10 including the container information (the height of the container 70, etc.) and the level setting value (value for the level Y, such as a threshold) are sequentially displayed on the display portion 20. Note that, in the initial setting 100, an operation condition of the level meter 10 such as whether the level meter 10 outputs an analog signal for a measurement value or performs serial communication with an external device may be set. On the other hand, there may be an operation condition that is not displayed in the initial setting 100 and is not set by the user. For example, an operation condition that one of the terminals included in the external output terminal 12D outputs an analog value may be determined in advance regardless of the user's operation. In addition, an operation condition that communication with an external device is automatically performed according to the external device connected to the level meter 10 may be determined in advance. For example, when the level meter 10 is connected to a device (master device) that manages the level meter 10, communication between the level meter 10 and the master device may be automatically performed by IO-Link communication defined in IEC61131-9 (IEC: International Electrotechnical Commission).

When the initial setting 100 is completed, the level meter 10 enters a measurement mode 500. In the measurement mode 500, the level meter 10 measures the level Y of the object 72. In the measurement mode 500, as illustrated in FIG. 1, the relative position of the level setting value with respect to the container 70 is displayed on the display portion 20 together with the bar display 22.

In the measurement mode 500, the display portion 20 can display a menu screen 600. The display screen of the measurement mode 500 for displaying the bar display 22 and the like and the menu screen 600 can mutually transition. For example, every time the user operates the menu key 32 in the measurement mode 500, the display content of the display portion 20 is preferably switched between the display screen of the measurement mode 500 and the menu screen 600.

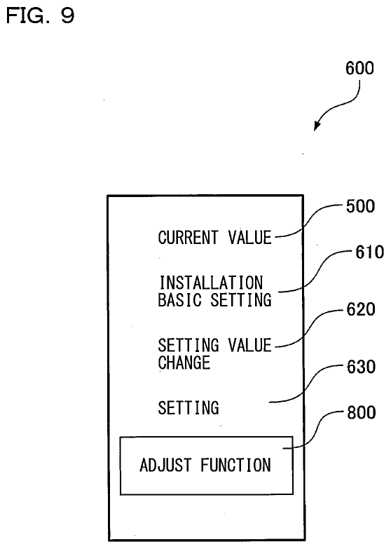

FIG. 9 illustrates an example of the menu screen 600. A plurality of options corresponding to individual setting contents are displayed on the menu screen 600. In response to the user's selection, the display contents of the display portion 20 transition from the menu screen 600 to individual setting screens such as a container setting screen 610 (a character string of “installation basic setting” in FIG. 9), a setting value change screen 620, a miscellaneous setting screen 630, and an adjustment function 800. The menu screen 600 and the individual setting screen can mutually transition. For example, when the menu key 32 and the up key 36 are simultaneously operated on individual setting screens, the display portion 20 preferably returns to the menu screen 600.

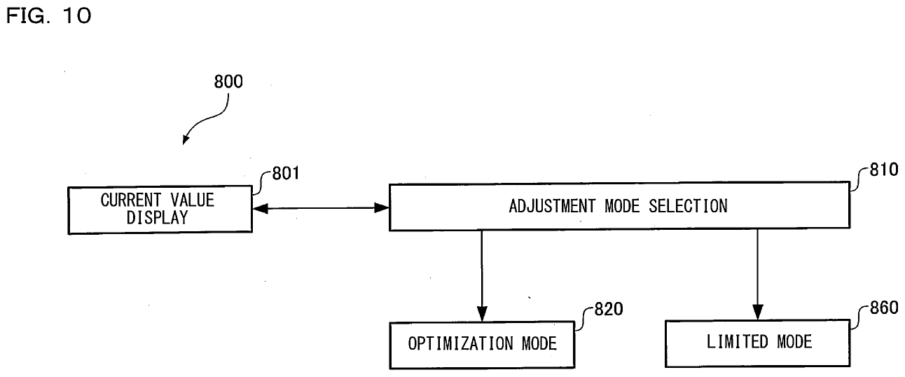

When the character string “adjust function” is selected on the menu screen 600, the level meter 10 starts the adjustment function 800. Various types of processing included in the adjustment function 800 may be realized, for example, by the calculation unit 64 executing a program stored in the storage unit 63. FIG. 10 illustrates a state transition of the level meter 10 in the adjustment function 800. When the adjustment function 800 is started, the level meter 10 first displays a current value display screen 801 in the display portion 20. The current value displayed on the current value display screen 801 is the measurement value related to the level Y determined by the measurement value determination unit 88 at that time. For example, the measurement value determination unit 88 sets, for example, a peak position of the strongest intensity among combinations (peak candidates) of the peak position and the peak intensity determined by the candidate determination unit 913 as the measurement value related to the level Y. The peak position of the strongest intensity corresponds to, for example, a value of a distance from the level meter 10 to the interface 74 of the object 72. However, at this point, there is also a possibility that the distance of elements other than the interface 74, such as the container built-in object 73, is displayed.

In addition, the current value display screen 801 can transition to an adjustment mode selection screen 810. On the adjustment mode selection screen 810, the user selects whether the processing for removing the peak candidate other than the target peak PS from the reception intensity distribution and determining the correct measurement value related to the object 72 is executed in an optimization mode 820 or a limited mode 860. In both the optimization mode 820 and the limited mode 860, the user selects which of the plurality of peak candidates is the target peak PS derived from the object 72. Then, in the optimization mode 820, diagnosis and setting optimization are executed. Specifically, the diagnosis related to the measurement environment of the measurement value (such as level Y) related to object 72 is executed based on the reception intensity distribution. According to the diagnosis result, a suggestion message indicating guidance regarding the measurement environment is displayed on the display portion 20. In addition, in the optimization mode 820, the optimization of the setting (for example, the setting of the tracking processing) necessary for determining the measurement value related to the object 72 is executed based on the target peak PS selected by the user and the diagnosis result.

On the other hand, in the limited mode 860, only learning based on the designation of the target peak PS by the user is executed. The learning is a setting related to the reception intensity distribution performed on the basis of the designated target peak PS, and as a specific example, is a setting (for example, setting of the mask region W_{A}, the background signal W_{B}, and the like) for removing a peak candidate other than the target peak PS from the reception intensity distribution. In the limited mode 860, other setting changes are not performed.

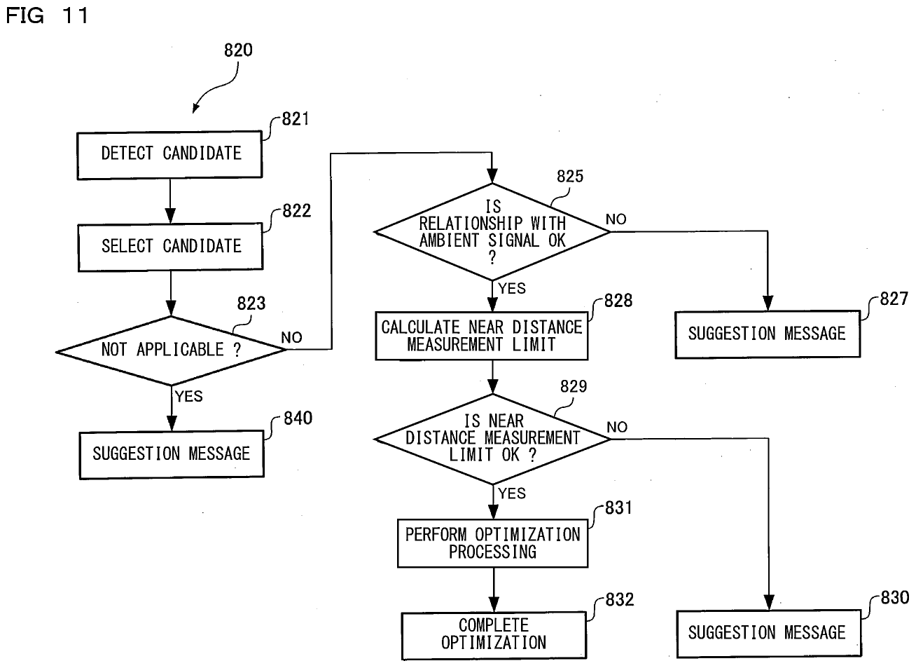

FIG. 11 is a flowchart illustrating a flow of processing in the optimization mode 820. When the optimization mode 820 starts, first, in step 821, a plurality of peak candidates are determined (detected as candidates) by the candidate determination unit 913.

When the determination of the peak candidate is completed, in step 822, processing (candidate selecting) of causing the user to select one of the plurality of peak candidates as the target peak PS derived from the object 72 to be measured is performed.

In the processing of selecting candidates, the display portion 20 displays information on the measurement value and the reception intensity corresponding to each of the peak candidates. With reference to the measurement value, the stability of the reception intensity, and the like, the user selects, as the target peak PS, a peak candidate that seems to represent the measurement value (distance from the level meter 10) of the object 72 to be measured. For example, if the user knows the design value of the container information (height or the like) of the container 70, the user can distinguish the peak candidate derived from the inner surface of the container 70 or the container built-in object 73 from the target peak PS derived from the object 72. In addition, for example, in a case where the object 72 is a liquid and the liquid level thereof is shaken, the user can estimate that the target peak is a peak having an unstable signal intensity. Here, options of “empty state” and “not applicable” are also displayed on the display portion 20. In a case where the object 72 is not stored in the container 70 (the container 70 is empty), the user may select an option of “empty state”. Note that the distance from the level meter 10 to the bottom of the container 70 may also be described in the option of the “empty state”. In addition, when considering that none of the displayed peak candidates represent the measurement value of the storage object 72 to be measured, the user may select the option of “not applicable”.

In step 823, it is determined whether the “not applicable” option has been selected. When the option of “not applicable” is selected (YES in step 823), the level meter 10 displays a suggestion message in the display portion 20 in step 840. The suggestion message of step 840 indicates that the level meter 10 has not been able to find the interface 74 of the object 72 by measurement and a suggestion to improve the measurement environment. For example, the display portion 20 displays a message such as “No liquid level signal has been found. Please increase the sensitivity setting or review the installation”. The level meter 10 ends the optimization mode 820 without learning and setting optimization after displaying the suggestion message of step 840.

Then, in step 823 of FIG. 11, in a case where the option of “not applicable” is not selected (NO in step 823), that is, in a case where any one of the peak candidates determined by the candidate determination unit 913 is selected as the target peak PS, the processing of the optimization mode 820 proceeds to step 825.

In step 825, diagnosis regarding the measurement environment is made based on the target peak PS and the reception intensity distribution. Specifically, it is determined whether there is a problem in the relationship between the selected target peak PS and the ambient signal R_{N}. For example, in a case where the signal intensity of the peak candidate selected by the user is extremely weaker than those of the other peak candidates, it is determined that there is a problem in the relationship with the ambient signal R_{N}. In a case where there is a problem in the relationship with the ambient signal R_{N} (NO in step 825), a suggestion message is displayed on the display portion 20 in step 827.

The suggestion message displayed in step 827 indicates that the influence of the ambient signal R_{N} is large with respect to the measurement by the level meter 10. That is, it is suggested that the intensity of the target peak PS may appear small due to the influence of the ambient signal R_{N}. Therefore, the suggestion message of step 827 suggests that the installation of the level meter 10 itself should be reviewed. After displaying the suggestion message in step 827, the level meter 10 learns the designated value of the user as the target peak PS, and ends the optimization mode 820.

On the other hand, in a case where there is no problem in the relationship with the ambient signal R_{N} (YES in step 825), the level meter 10 proceeds to step 828, and calculates the near distance measurement limit by using the intensity of the peak candidate selected by the user, the peak that has not been selected from the peak candidates appearing at the near distance of the level meter 10, and the data of the reflection (for example, the stray signal wave caused by the internal reflection of the container 70 or the like) that can be generated from other than the object 72 at the near distance. In the calculation of the near distance measurement limit, the limit on the near distance side (how far the measurement can be performed) is confirmed for the measurement range by the level meter 10. The reflection signal Rx from a position that is too close to the level meter 10 may include effects such as the internal reflection of the container 70, so that a valid measurement value is obtained from a position that is somewhat distant from the level meter 10.

Subsequently, in step 829, it is confirmed (diagnosed) whether there is a problem in the calculation result of the near distance measurement limit. For example, the calculation value of the near distance measurement limit is displayed on the display portion 20, and the user selects whether there is no problem with the distance as the limit on the near distance side of the measurement range.

In a case where there is a problem in the calculation result of the near distance measurement limit (NO in step 829), the processing in the optimization mode 820 proceeds to step 830, and a suggestion message regarding the result of the distance measurement is displayed on the display portion 20. In the suggestion message of Step 830, for example, that the sensitivity setting of the near distance measurement should be increased, that the installation of the level meter 10 should be reviewed, and the like are displayed.

On the other hand, in a case where there is no problem in the calculation result of the near distance measurement limit (YES in step 829), the processing in the optimization mode 820 proceeds to step 831, and the optimization processing of the measurement condition is started. After the optimization processing is completed, in step 832, a screen indicating that the optimization processing is completed is displayed on the display portion 20, and the optimization mode 820 is completed.

In step 831, the diagnosis related to the measurement environment is performed based on the selected target peak PS and the reception intensity distribution. Then, the optimization of the setting necessary for determining the measurement value related to the object 72 is executed according to the diagnosis result. In the diagnosis related to the measurement environment, it is estimated whether an element that reflects the measurement signal Tx is present in the container 70 other than the object 72, and where the element exists when the element exists. It is presumed that the selected target peak PS is derived from the reflection signal Rx obtained by reflecting the measurement signal Tx by the object 72 to be measured, whereas the ambient peak P_{N} is derived from the ambient signal R_{N} obtained by reflecting the measurement signal Tx by an element other than the object 72. Therefore, it is possible to estimate an element other than the object 72 from the relationship between the target peak PS and the ambient peak P_{N} in the reception intensity distribution. In the optimization of the setting necessary for determining the measurement value related to the object 72, the measurement condition necessary for the level meter 10 to continuously specify the position of the peak PS included in the reception intensity distribution target during the measurement is set. For example, in addition to setting of the mask region W_{A} and the background signal W_{B}, setting of intensity priority and near-distance priority at the time of selecting a peak position, and setting of a duration of tracking and a range of an estimated position are performed.

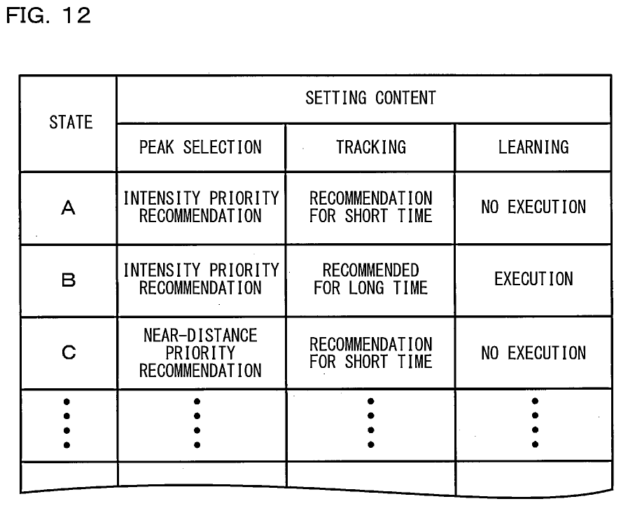

FIG. 12 illustrates setting contents according to the diagnosis result (state of measurement environment). FIG. 12 illustrates items of “peak selection”, “tracking”, and “learning” indicating setting contents to be applied. The item of “peak selection” is a setting of which peak is preferentially regarded as the target peak PS in a case where there are a plurality of peaks (for example, intensity priority or near-distance priority). An item of “tracking” is a setting of whether it is recommended to terminate the tracking processing of searching for a peak near the lost position in a short time or to continue the tracking processing for a long time in a case where the level meter 10 loses sight of the target peak PS. In addition, the item of “learning” is a setting of whether it is recommended to store (learn) data necessary for removing peak candidates other than the target peak PS, such as data regarding the mask region W_{A} and the background signal W_{B}, for the reception intensity distribution.

For example, in a case where it is expected that the intensity of the target peak PS is stronger than the intensities of other peak candidates (ambient peaks P_{N}), the intensity of “peak selection” is set to “intensity priority recommendation”. In a case where the target peak PS is expected to remain in the mask region W_{A} and the background signal W_{B} for a long period of time, the item “tracking” is set to “long time recommendation”. In a case where the level meter 10 can specify the target peak PS without removing the ambient peak P_{N}, the item of “learning” is “no execution”.

In FIG. 12, the state (diagnosis result) of the measurement environment is classified into a state A, a state B, a state C, and the like, and appropriate setting contents are determined in advance for each state. By applying predetermined appropriate setting contents, optimization of settings necessary for determining a measurement value related to the distance or the level Y of the object 72 is automatically performed. For example, if the state of the measurement environment is “A”, the setting contents are applied such that the setting of the peak selection is “intensity priority recommendation”, the setting of the tracking is “short time recommendation”, and the setting of the learning is “execution”. Note that, as illustrated in FIG. 12, depending on the state, the setting of the peak selection may be “near-distance priority recommendation”, the setting of the tracking may be “long time recommendation”, or the setting of the learning may be “execution”.

When the optimization processing of the optimization mode 820 (FIG. 11) is completed as described above, the setting items related to the measurement of the level Y, particularly, the setting items related to “peak selection”, “tracking”, and “learning” are automatically set. Since these settings are automatically performed by the level meter 10, the user's operation only selects level candidates corresponding to the target peak PS, and it is not necessary to finely set each of the setting items. In addition, in a case where the measurement environment is inappropriate in the optimization mode 820, a suggestion message for improving the measurement environment is displayed on the display portion 20. By checking the suggestion message, the user can grasp work (for example, review of the installation state of the level meter 10) to be performed in order to correctly perform measurement. Therefore, the level meter 10 of the present embodiment is highly convenient for the user.

However, since the automatically set setting item is merely “recommendation”, it may not be an optimal setting depending on the measurement environment. Therefore, it is preferable that various setting items can be changed according to a user's desire. For example, when options (character strings of “setting”) on the miscellaneous setting screen 630 are selected on the menu screen 600 in FIG. 9, screens for changing various measurement conditions including setting items such as “peak selection” and “tracking” are preferably displayed on the display portion 20. In addition, the optimization of the setting necessary for determining the measurement value related to the distance or the level Y of the object 72 may be executed in a question and answer format (wizard format) according to the user's desire. Specifically, a question (for example, container information regarding the dimensions of the container 70, a question regarding the presence or absence of the container built-in object 73, and the like) regarding the measurement condition of the level Y is displayed on the display portion 20, and the user inputs an answer to the question. Then, the measurement value determination unit 88 executes optimization of setting necessary for determining the measurement value related to the distance or the level Y of the object 72 based on the input answer.

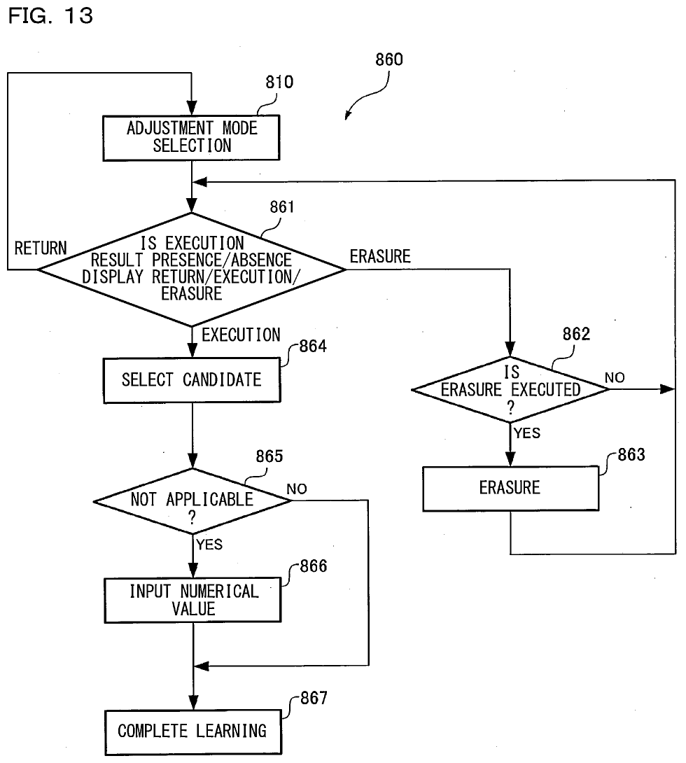

Next, a case where the limited mode 860 is selected on the adjustment mode selection screen 810 of FIG. 10 will be described. FIG. 13 is a flowchart of a processing flow in the limited mode 860. When the limited mode 860 is started, first, in step 861, a screen (execution result presence/absence display) indicating whether an existing learning execution result exists is displayed on the display portion 20.

A plurality of options are displayed on the screen of the execution result presence/absence display. The options in the execution result presence/absence display include an option (“return”) to return to the previous screen (the adjustment mode selection screen 810) and an option (“execution”) to execute learning. In a case where there is an existing learning execution result (case where setting of the mask region W_{A}, the background signal W_{B}, and the like for removing ambient peak P_{N} is already completed), a display indicating that there is an existing learning result (for example, “Learning execution result: present”) is performed. In addition, in a case where there is an existing learning execution result, an option of erasing the existing learning execution result (“erasure”) is also included in the options in the execution result presence/absence display. When the user selects the option of “erasure” in step 861 (for example, operating the menu key 32 while the option of “erasure” is displayed), the processing of the limited mode 860 proceeds to step 862.

In step 862, a screen (erasure necessity confirmation) for confirming whether to actually erase the existing learning execution result is displayed on the display portion 20. In step 862, the user selects whether to execute erasure of an existing learning execution result. In a case where it is selected not to execute erasure (NO in step 862), the display of the display portion 20 returns to the screen of the execution result presence/absence display (return to step 861).

When the user selects to erase the existing learning execution result in step 862 (YES in step 862), the processing of the limited mode 860 proceeds to step 863, and the existing learning execution result is erased by erasing the information regarding the already selected target peak PS and the information (setting of the mask region W_{A}, the background signal W_{B}, etc.) for removing the peak candidate other than the target peak PS from the reception intensity distribution. When the existing learning execution result is erased, the processing in the limited mode 860 returns to step 861.

When the user selects the option of “execution” in step 861, the execution of learning is started. When the execution of the learning is started, the processing of the limited mode 860 proceeds to step 864, and processing (candidate selection) of causing the user to select one of the plurality of peak candidates determined by the candidate determination unit 913 as the target peak PS derived from the object 72 to be measured is performed.

In the candidate selection in step 864 in the limited mode 860, a screen similar to that in the case of the candidate selection in step 822 (FIG. 11) in the optimization mode 820 is displayed on the display portion 20. The screen for candidate selection may include options of “not applicable” and “empty state”.

After the candidate selection in step 864, it is determined in step 865 whether the option of “not applicable” has been selected. In a case where the option of “not applicable” is selected (YES in step 865), processing of inputting a numerical value is performed in step 866. In the processing of inputting a numerical value, the user specifies and inputs the current numerical value of the measurement value of the object 72 to be measured.

After the numerical value input is performed in step 866, or in a case where the option of “not applicable” is not selected (NO in step 865), that is, a case where any one of the peak candidates determined by the candidate determination unit 913 is selected as the target peak PS, the processing of the limited mode 860 proceeds to step 867.

In step 867, the peak candidate selected by the user or the peak at the peak position of the numerical value input by the user is stored as the target peak PS, and setting (for example, setting of the mask region W_{A}, the background signal W_{B}, and the like) for removing the other peak candidates from the reception intensity distribution is performed. Then, a screen indicating that the learning is completed is displayed on the display portion 20, and the limited mode 860 is completed.

In the case of the limited mode 860, default settings predetermined in the initial settings 100 and the like are applied as the measurement conditions including setting items such as “peak selection” and “tracking” automatically set in the optimization mode 820. The user may manually change the measurement condition from the menu screen 600 or the like as necessary.

In both cases of the optimization mode 820 in which diagnosis and setting optimization are executed and the limited mode 860 in which only learning is executed, setting (for example, setting of the mask region W_{A}, the background signal W_{B}, and the like) for removing peak candidates other than the target peak PS from the reception intensity distribution is automatically performed by the measurement value determination unit 88. For example, when the user selects the target peak PS, the measurement value determination unit 88 stores the waveform of the peak candidate (other than the selected target peak PS) appearing in the reception intensity distribution in the storage unit 63 as the waveform of the background signal W_{B}. When the measurement value determination unit 88 determines the measurement value of the object 72, the waveform of the background signal W_{B} is removed from the reception intensity distribution, and the distance or the level Y of the object 72 from the level meter 10 is determined based on the target peak PS.

If the setting for removing the peak candidate other than the target peak PS from the reception intensity distribution is automatically performed, the user does not need to be aware of a complicated waveform based on the measurement signal Tx, the reflection signal Rx, the ambient signal R_{N}, and the like when removing unnecessary information such as the ambient peak P_{N}. Therefore, the user can complete the setting of the measurement condition necessary for the measurement of the level Y with a simple operation of selecting the target peak PS from the given options.

Note that, after the target peak PS is selected in the optimization mode 820 or the limited mode 860 and until the information regarding the target peak PS is erased, only the information regarding the measurement value and the reception intensity corresponding to the target peak PS may be displayed as the peak candidate so that it can be confirmed that the peak candidate other than the target peak PS is removed from the reception intensity distribution. For example, when the adjustment function 800 is executed again after the selection of the target peak PS and the screen for selecting the peak candidate is displayed on the display portion 20, only the information of the selected target peak PS may be displayed as the peak candidate.

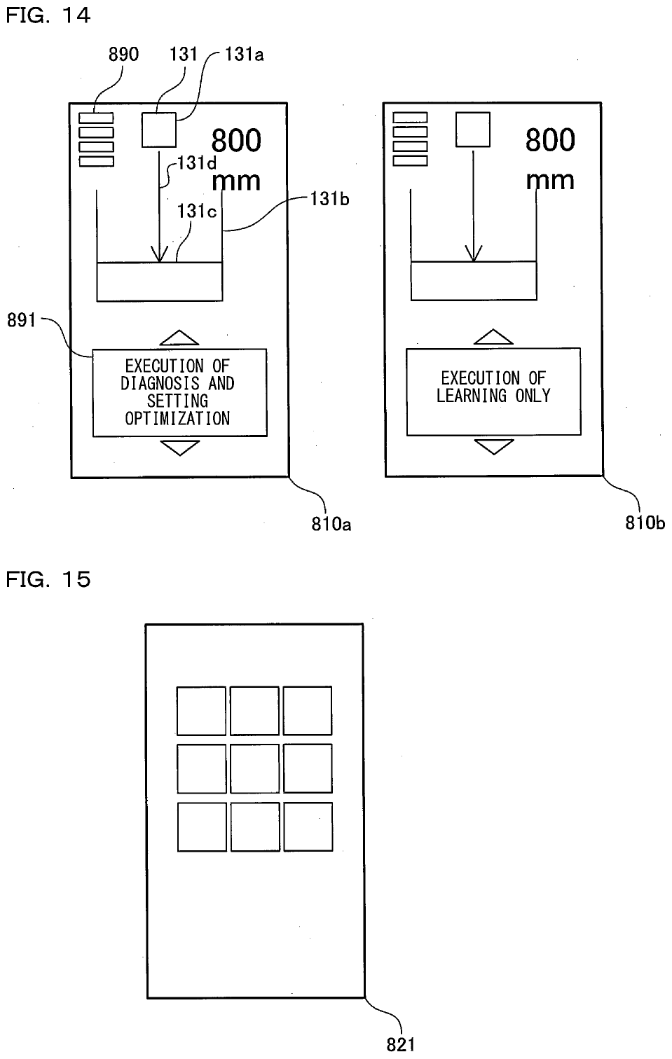

Next, a specific example of an individual display screen displayed on the display portion 20 in the adjustment function 800 of FIG. 10 will be described with reference to the drawings. In the description of the specific example of the display screen, the detailed description of the processing performed on each screen may be simplified. In addition, the order of explanation of the screens does not necessarily coincide with the order of processing. First, FIG. 14 illustrates an optimization mode selection screen 810a and a limited mode selection screen 810b that function as the adjustment mode selection screen 810 of FIG. 10. The optimization mode selection screen 810a and the limited mode selection screen 810b include an interface position icon 131 and a reception intensity scale 890 in addition to the distance value (here, 800 mm) measured by the level meter 10. In addition, a selection field 891 for displaying options is displayed in the lower part of the current value display screen 801. On the optimization mode selection screen 810a, a character string “execution of diagnosis and setting optimization” is displayed in the selection field 891. On the limited mode selection screen 810b, a character string “execution of only learning” is displayed in the selection field 891. The display of the selection field 891 is switched when the user operates the down key 35 or the up key 36.

The interface position icon 131 includes a figure 131a (quadrangle in FIG. 14) imitating the level meter 10, a figure 131b imitating the container 70 and a line 131c indicating the interface 74 of the object 72, which are arranged below the figure 131a, and an arrow 131d extending from the figure 131a imitating the level meter 10 to the line 131c of the interface 74. The line 131c indicating the interface 74 is displayed at a position of the ratio corresponding to the size of the measurement value with respect to the dimension of the entire container 70 (the height of the container 70) in the figure 131b imitating the container 70. The interface position icon 131 visually and intelligibly displays to the user that the displayed measurement value indicates the distance from the level meter 10 to the interface 74 and a scale of the ratio of the distance to the dimension of the entire container.

The reception intensity scale 890 indicates information on the intensity (reception intensity) of the radio wave received by the reception circuit 43R for the reflection signal Rx or the ambient signal R_{N} corresponding to the peak candidate on which the displayed measurement value is calculated. For example, the intensity of the radio wave received by the reception circuit 43R is classified into several stages (here, 4 stages), and the stage of the strength of the reflection signal Rx or the ambient signal R_{N}, which is the basis for calculating the displayed measurement value, is indicated by the number of the reception intensity scales 890. For example, if the reflection signal Rx or the ambient signal R_{N} is strong, the number of the reception intensity scales 890 is displayed large (up to 4). When the reflection signal Rx or the ambient signal R_{N} is weak, the number of the reception intensity scales 890 is displayed small (at least one).

The number of the reception intensity scales 890 dynamically varies depending on the strength of the radio wave received by the reception circuit 43R at the time of display. Therefore, if the intensity of the radio wave received by the reception circuit 43R is unstable, the number of the reception intensity scales 890 varies in a short period of time. Note that the information regarding the reception intensity only needs to dynamically change according to the magnitude of the reception intensity, and may be displayed in a form different from the reception intensity scale 890. For example, the reception intensity may be numerically displayed, or the stability of the intensity may be displayed by characters such as “dynamic” (not stable) and “static” (stable).

Hereinafter, the interface position icon 131 and the reception intensity scale 890 may be displayed on other screens, but descriptions and reference signs regarding the interface position icon 131 and the reception intensity scale 890 on other screens are omitted unless otherwise specified.

When the menu key 32 is operated on the optimization mode selection screen 810a, the optimization mode 820 (FIG. 11) is executed, and when the menu key 32 is operated on the limited mode selection screen 810b, the limited mode 860 (FIG. 13) is executed.

In both the optimization mode 820 and the limited mode 860, a wait screen 821 of FIG. 15 may be displayed on the display portion 20 while the processing in the processing unit 62 is performed. For example, the wait screen 821 is displayed while the candidate determination unit 913 determines (detects candidates) a plurality of peak candidates in the optimization mode 820. An animation image is displayed on the wait screen 821 to indicate that processing in the processing unit 62 is waited. For example, as illustrated in FIG. 15, a plurality of quadrangles are displayed side by side, and an animation in which the sizes of these quadrangles sequentially change is displayed. The animation display is displayed every time the processing is waited, but the description thereof will be omitted below.

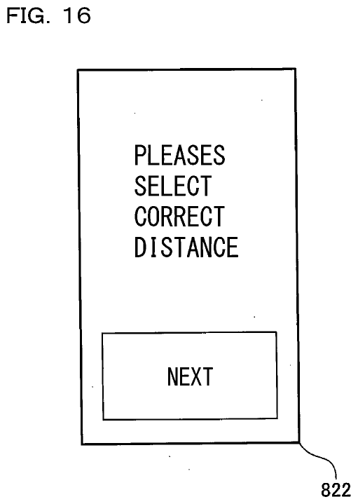

Before candidate selection in step 822 is performed in the optimization mode 820 (FIG. 11), a candidate selection message illustrated in FIG. 16 is displayed on the display portion 20. The candidate selection message prompts the user to select a numerical value representing the correct distance of the object 72 on the next screen.

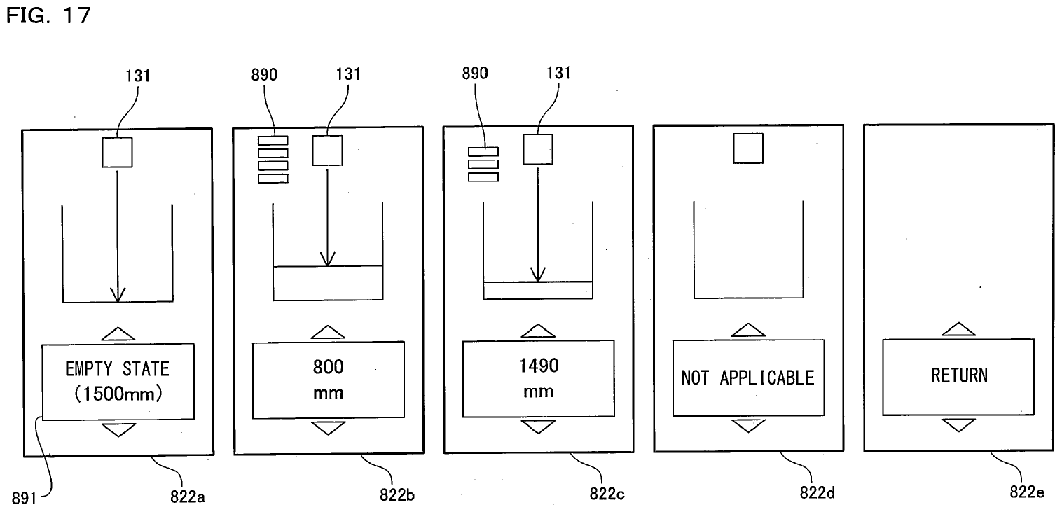

When the menu key 32 is operated with respect to the candidate selection message, a candidate confirmation screen illustrated in FIG. 17 is displayed on the display portion 20. The candidate confirmation screen of FIG. 17 includes a first candidate confirmation screen 822a, a second candidate confirmation screen 822b, a third candidate confirmation screen 822c, a fourth candidate confirmation screen 822d, and a cancel screen 822e. When the down key 35 or the up key 36 is operated, these screens are switched to each other.

The first candidate confirmation screen 822a displays that the container 70 is in the empty state and the distance (here, 1500 mm) to the bottom of the container 70 in the empty state. The indication of the empty state is displayed in the selection field 891 at the bottom of the screen. Information indicating signal intensity is not displayed on the first candidate confirmation screen 822a. In addition, the arrow included in the interface position icon 131 reaches the bottom of the figure indicating the container 70.

On the second candidate confirmation screen 822b, a value “800 mm” of the peak position (distance) of the peak candidate, an interface position icon 131, and a reception intensity scale 890 are displayed. The value of the peak position is displayed in the selection field 891. The reception intensity scale 890 of the second candidate confirmation screen 822b is 4 scales (signal is strong).

On the third candidate confirmation screen 822c, a value “1490 mm” of the peak position of the peak candidate, an interface position icon 131, and a reception intensity scale 890 are displayed. The reception intensity scale 890 of the third candidate confirmation screen 822c is 3 scales (signal is slightly weak).

On the fourth candidate confirmation screen 822d, a character string “not applicable” is displayed in the selection field 891 instead of the value of the peak position. In a case where the user considers that any of the peak candidates is not appropriate as the position of the interface 74 of the object 72, the fourth candidate confirmation screen 822d is selected. Information indicating signal intensity is not displayed on the fourth candidate confirmation screen 822d. In addition, an arrow is not displayed on the interface position icon 131.

In the cancel screen 822e, a character string “return” is included in the selection field 891. Information indicating the signal intensity and the interface position icon 131 are not displayed on the cancel screen 822e. When the menu key 32 is operated on the cancel screen 822e, the display of the display portion 20 returns to the adjustment mode selection screen (FIG. 14).

The user selects one of the peak candidates as the target peak PS by operating the menu key 32 on a screen (for example, the second candidate confirmation screen 822b and the third candidate confirmation screen 822c) indicating a peak position of a peak candidate considered to correspond to the target peak PS. In a case where the fourth candidate confirmation screen 822d (not applicable) is selected in the optimization mode 820, a suggestion message indicating that the liquid level signal has not been found and a suggestion for improving the measurement environment are displayed on the display portion 20.

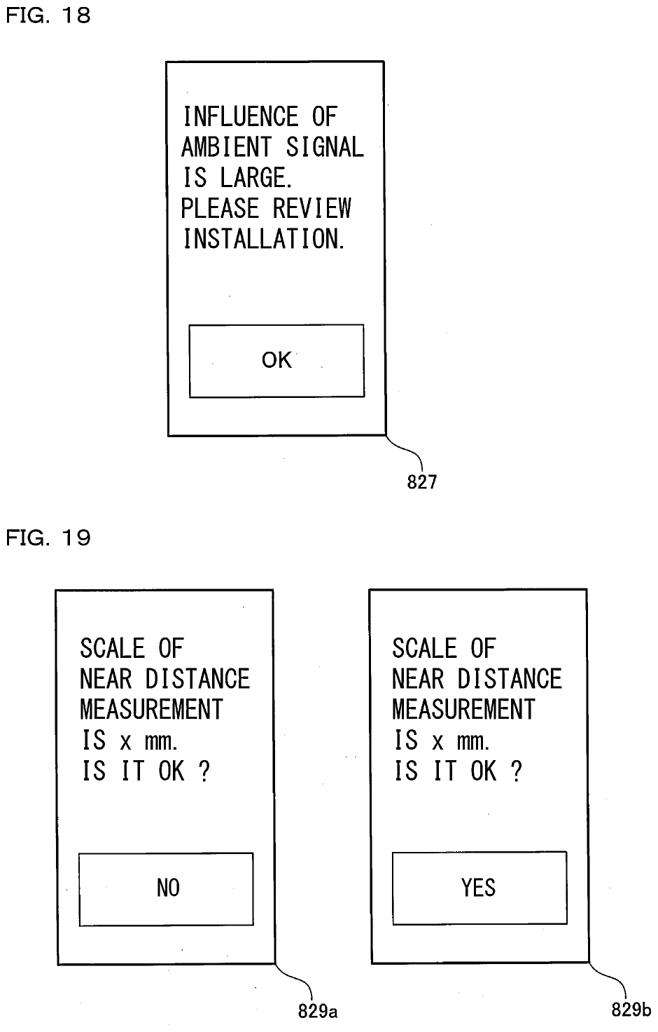

FIG. 18 illustrates a suggestion message in a case where there is a problem in the relationship between the target peak PS selected by the user and the ambient signal R_{N} (step 827 in FIG. 11). This suggestion message suggests that the influence of the ambient signal R_{N} is large with respect to the measurement by the level meter 10, and suggests that the installation of the level meter 10 itself should be reviewed.

FIG. 19 illustrates a calculation result confirmation screen of the near distance measurement limit (step 829 in FIG. 11). The calculation result confirmation screen of the near distance measurement limit can be switched between a result negative screen 829a and a result approval screen 829b by operating the down key 35 or the up key 36. When the menu key 32 is operated on the result negative screen 829a, there is a problem in the calculation result of the near distance measurement limit. When the menu key 32 is operated on the result approval screen 829b, there is no problem in the calculation result of the near distance measurement limit.

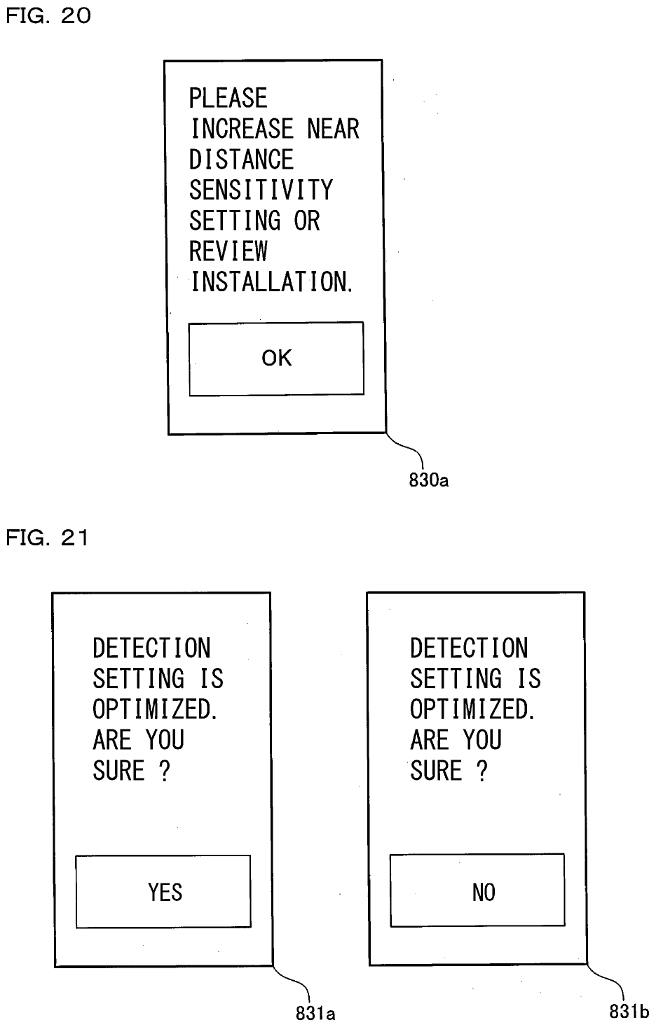

FIG. 20 illustrates a suggestion message 830a in a case where the calculation result of the near distance measurement limit is not preferable (step 830 in FIG. 11). The suggestion message 830a displayed here suggests that the installation of the level meter 10 should be reviewed. Then, the suggestion message 830a suggests to increase the near distance sensitivity setting (to set the sensitivity to be high).

FIG. 21 illustrates a start confirmation screen of the optimization processing. This screen is displayed when the optimization processing is started (step 831 in FIG. 11). The start confirmation screen of the optimization processing can be switched between a start affirmative screen 831a and a start negative screen 831b by operating the down key 35 or the up key 36. When the menu key 32 is operated on the start affirmative screen 831a, the optimization processing is started. When the menu key 32 is operated on the start negative screen 831b, the optimization processing is canceled, and the display of the display portion 20 returns to the adjustment mode selection screen (FIG. 14).

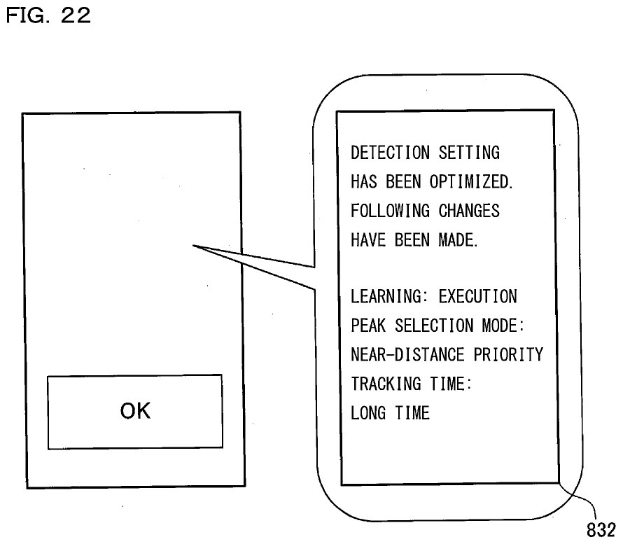

FIG. 22 illustrates an optimization completion screen. This screen is displayed when the optimization processing is completed (step 832 in FIG. 11). The optimization completion screen displays that the detection setting (measurement condition) has been optimized and what kind of setting has been specifically performed by the optimization. FIG. 22 illustrates that learning is executed, that the peak selection mode is set to “near-distance priority”, and that tracking is performed for a long time. Since the display content of the optimization completion screen has a large amount of information, the display portion 20 may not be able to collectively display all the information in one screen. In such a case, the display content of the optimization completion screen may be scrolled by the operation of the down key 35 or the up key 36. Then, when all the display contents to be displayed are displayed and the scroll reaches the lowermost end, “OK” is displayed on the display portion 20. When the menu key 32 is operated in a state where “OK” is displayed, the optimization is completed, and the display of the display portion 20 returns to the adjustment mode selection screen (FIG. 14).

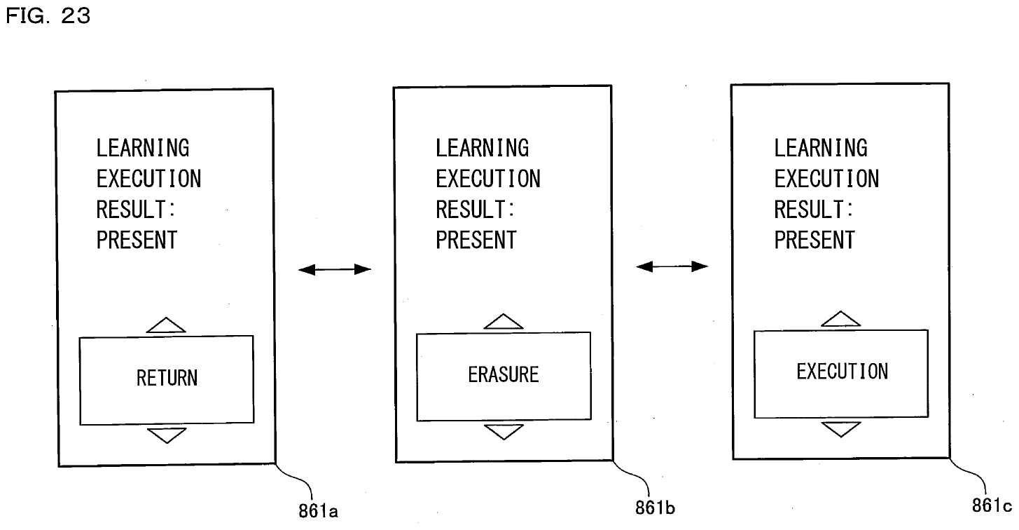

Next, FIG. 23 illustrates a display screen (step 861 in FIG. 13) of the presence or absence of the learning execution result in the limited mode 860. There are three types of display screens for the presence or absence of the learning execution result: a cancel selection screen 861a, an erasure selection screen 861b, and a learning execution selection screen 861c. These screens include a display (“present”) indicating that an existing learning execution result exists. In a case where there is no existing learning execution result, display such as “none” is performed. The cancel selection screen 861a, the erasure selection screen 861b, and the learning execution selection screen 861c are different from each other in the character string (“return”, “erasure”, and “execution”, respectively) displayed in the selection field at the bottom of the screen. These screens can be mutually switched by the user operating the down key 35 or the up key 36. When the menu key 32 is operated while the selection field is in the “return” state (cancel selection screen 861a), the display of the display portion 20 returns to the adjustment mode selection screen (FIG. 14).

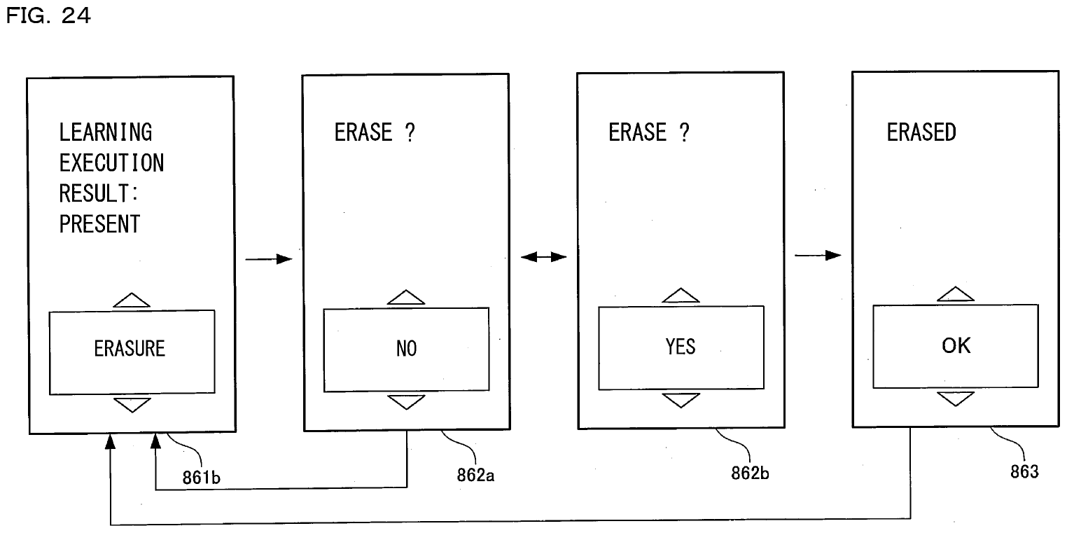

FIG. 24 illustrates the erasure necessity confirmation screen (step 862 in FIG. 13) of the learning execution result and the screen transition thereof. When the menu key 32 is operated while the selection field on the display screen indicating the presence or absence of the learning execution result is in the state of “erasure” (erasure selection screen 861b), the display of the display portion 20 transitions to an erasure negative screen 862a.

In the selection field of the erasure negative screen 862a, a message (“No”) indicating that it is not necessary to erase the existing learning execution result is displayed. When the menu key 32 is operated on this screen, the display of the display portion 20 returns to the erasure selection screen 861b. The erasure negative screen 862a can transition to and from an erasure affirmative screen 862b by operating the down key 35 or the up key 36.

In the selection field of the erasure affirmative screen 862b, a message (“Yes”) indicating that the existing learning execution result should be erased is displayed. When the menu key 32 is operated on this screen, the existing learning execution result is erased, and the display of the display portion 20 transitions to an erasure completion screen 863. The erasure completion screen 863 displays that the existing learning execution result has been erased. When the menu key 32 is operated on the erasure completion screen 863, the display of the display portion 20 transitions to the erasure selection screen 861b. However, after the erasure of the learning execution result, the existing learning execution result is displayed as “none” on the erasure selection screen 861b.

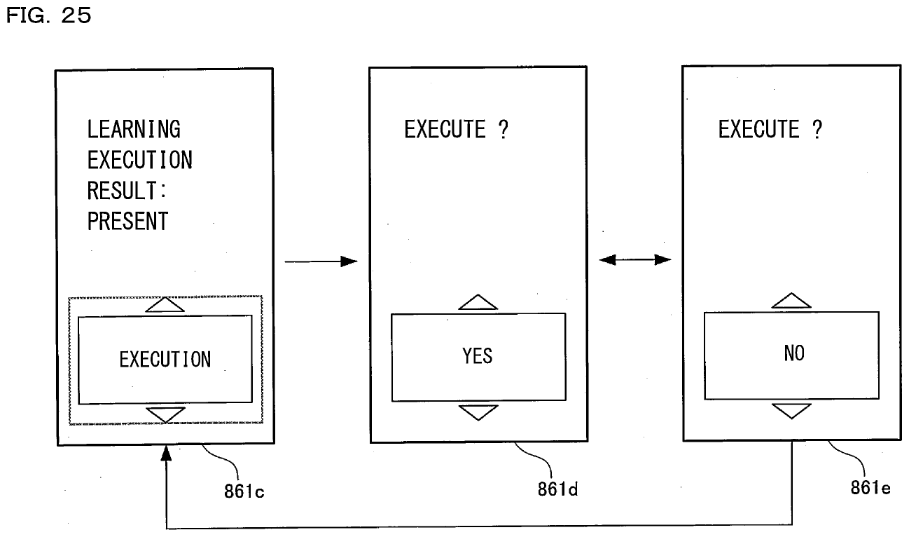

FIG. 25 illustrates a learning execution confirmation screen. When the menu key 32 is operated on the learning execution selection screen 861c, the display of the display portion 20 transitions to an execution affirmative screen 861d. The execution affirmative screen 861d can be switched to an execution negative screen 861e by operating the down key 35 or the up key 36. When the menu key 32 is operated on the execution affirmative screen 861d, the execution of learning is started, and a peak candidate is selected (step 864 in FIG. 13). When the menu key 32 is operated on the execution negative screen 861e, the display of the display portion 20 returns to the learning execution selection screen 861c.

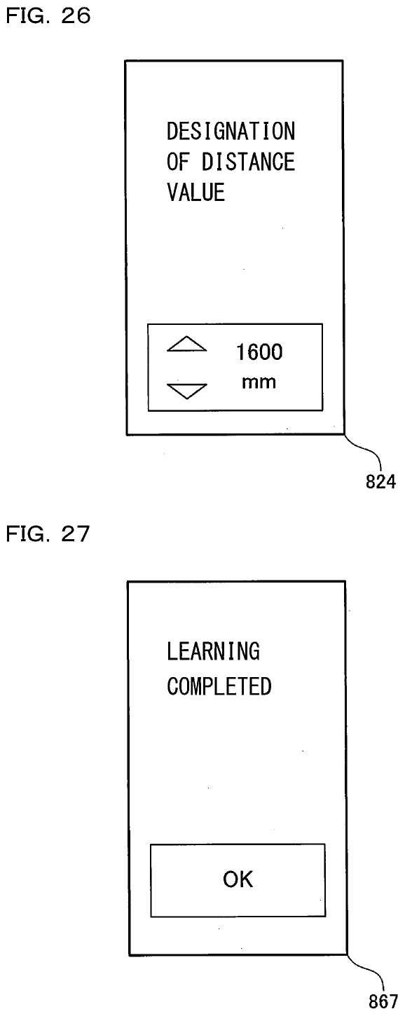

Similarly to the optimization mode 820, also in the limited mode 860, the candidate confirmation screen of FIG. 17 is displayed on the display portion 20 at the time of selecting a peak candidate. Then, in a case where the option (the fourth candidate confirmation screen 822d) indicating “not applicable” is selected in the limited mode 860, the display in the display portion 20 transitions to a numerical value input screen related to the distance illustrated in FIG. 26. On the numerical value input screen, the user can continuously change the numerical value of the distance displayed in the selection field by operating the down key 35 or the up key 36. The user adjusts the displayed numerical value to an appropriate numerical value as the peak position of the target peak PS, and then operates the menu key 32 to input the distance value of the target peak PS.

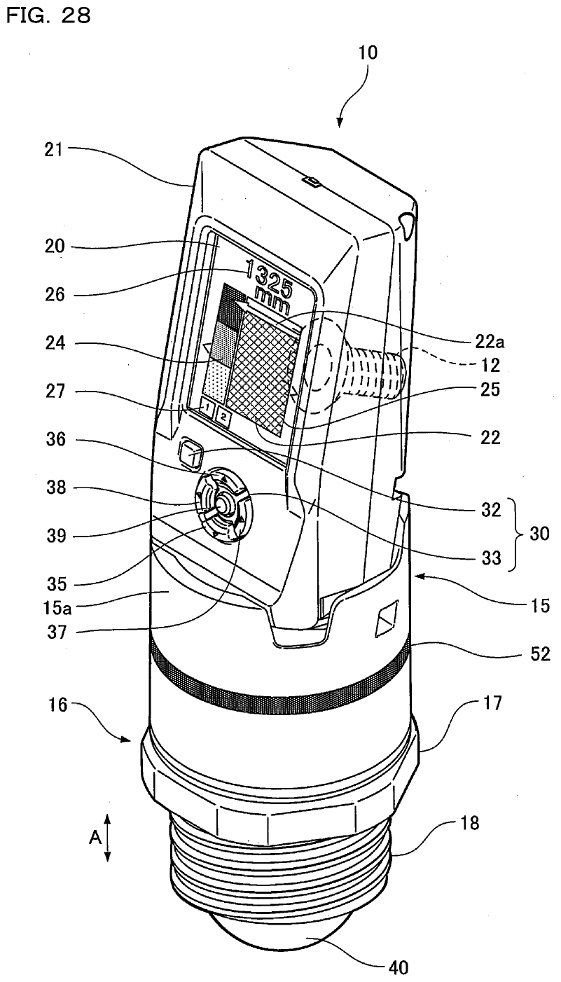

FIG. 27 illustrates a learning completion screen in the limited mode 860. This screen is displayed when the learning is completed in the limited mode 860 (step 867 in FIG. 13). When the menu key 32 is operated on this screen, the display of the display portion 20 returns to the adjustment mode selection screen (FIG. 14).

Next, another example of the level meter 10 will be described with reference to FIG. 28. FIG. 28 is a perspective view illustrating another example of the level meter 10. In FIG. 28, components having the same functions as those of level meter 10 in FIGS. 1 and 2 are denoted by the same reference numerals as those in FIGS. 1 and 2, and the description thereof will not be repeated unless necessary.

The housing 15 of the level meter 10 in FIG. 28 includes a base 15a and a terminal 21. The base 15a is disposed on one end side (lower side) in the longitudinal direction A (the direction of the measurement axis) in the housing 15. The terminal 21 is disposed on the other end side in the longitudinal direction A. In FIG. 28, the display portion 20 is provided in the terminal 21. In addition, the terminal 21 can be separated from the base 15a. The base 15a has a cylindrical shape, while the terminal 21 has a prismatic shape.

The terminal 21 may be fixed to the base 15a by a fastening screw on the back surface side with respect to the display portion 20. In addition, a connection connector that transmits an electric signal between the base 15a and the terminal 21 is preferably provided. For example, one of the pair of connection connectors may be provided on the base 15a, and the other of the pair of connection connectors may be provided on the terminal 21. Connecting the pair of connection connectors enables transmission and reception of an electric signal between the base 15a and the terminal 21. Further, when the terminal 21 is separated from the base 15a, the connection connectors are connected between the base 15a and the terminal 21 via a cable that transmits and receives an electric signal. As a result, even in a state where the terminal 21 is separated from the base 15a, the display portion 20 can display corresponding to the measured level Y. In this way, when the terminal 21 can be separated from the base 15a, the user can confirm the display of the display portion 20 at a position away from the base 15a. For example, in a case where the level meter 10 is disposed at a position higher than the viewpoint of the user, the user may have difficulty in confirming the display of the display portion 20. Here, when the terminal 21 can be separated from the base 15a, the user can easily confirm the display portion 20 at the site where the container 70 is installed by pulling the terminal 21 to the height of his/her viewpoint.

In FIG. 28, the connection portion 12 is disposed in a portion of the terminal 21 opposite to the display portion 20. By rotating the housing 15, the user can orient the connection portion 12 in a direction in which it is easy to handle.

In addition, in FIG. 28, the status lamp 52 is disposed on an outer peripheral surface of the base 15a in the housing 15. Therefore, the status lamp 52 in FIG. 28 is provided on one end side (lower side) in the longitudinal direction A with respect to the display portion 20. Although not illustrated in FIG. 28, the state LED 50 of the status lamp 52 is disposed inside the sensor unit 16.

In addition, the direction keys 33 in FIG. 28 include a left key 38, a right key 37, and a center key 39 in addition to an up key 34 and a down key 35. The user can easily switch the display mode of the display portion 20 by operating these keys, and can easily change various setting values in the setting mode. In addition, the operation of the left key 38 may have a function similar to the simultaneous operation of the menu key 32 and the up key 36 in the level meter 10 in FIGS. 1 and 2.

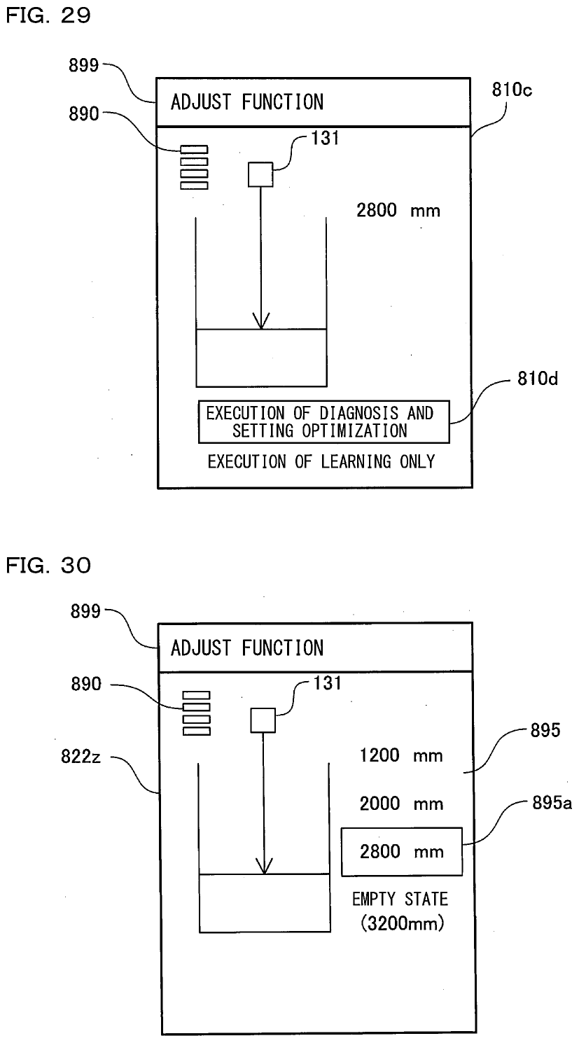

Hereinafter, some of the screens displayed on the display portion 20 of the level meter 10 in FIG. 28 will be described as another example of individual screens in the level meter 10 of FIGS. 1 and 2. Since the display portion 20 of the level meter 10 in FIG. 28 is larger than the display portion 20 of the level meter 10 in FIGS. 1 and 2, there is a margin in the display space as a whole. FIG. 29 illustrates another example of the adjustment mode selection screen of FIG. 14. In an adjustment mode selection screen 810c of FIG. 29, a sufficient interval is secured between the interface position icon 131 and the reception intensity scale 890 and the display of the current value (here, 2800 mm) as compared with the display of FIG. 14. In addition, a title bar 899 of “adjusting function” indicating that this screen is a part of the adjustment function 800 is displayed in the upper part of the screen. Then, an option of “execution of diagnosis and setting optimization” indicating the optimization mode 820 and an option of “execution of learning only” indicating the limited mode 860 are displayed below the adjustment mode selection screen 810c. The user moves a cursor 810d up and down by operating the up key 34 or the down key 35 to select one of the options. In this manner, on the adjustment mode selection screen 810c of FIG. 29, the display of the options is not switched, but all the selectable options are collectively displayed.

In FIG. 30, another example of the candidate confirmation screen of FIG. 17 is displayed. In a candidate confirmation screen 822z of FIG. 30, a plurality of options (1200 mm, 2000 mm, 2800 mm here, empty state: 3200 mm) of the peak position (distance) of the peak candidate are collectively displayed on one screen in a candidate display area 895 on the right side of the screen. The user moves a cursor 895a up and down by operating the up key 34 or the down key 35 to select one of the options. Therefore, the user does not need to switch the display to confirm the candidate value as illustrated in FIG. 17. Note that, although not displayed in FIG. 30, an option of “not applicable” may also be displayed. The title bar 899 of “adjust function” is also displayed on the candidate confirmation screen 822z.

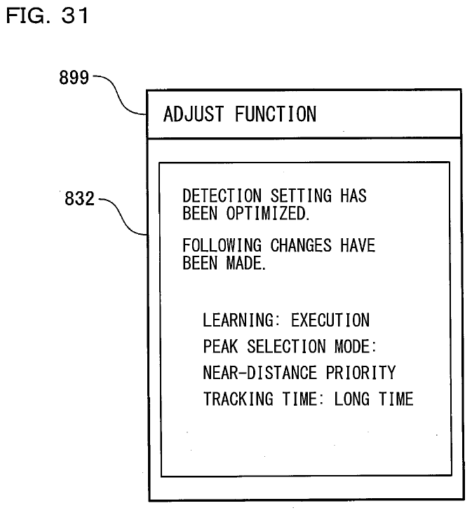

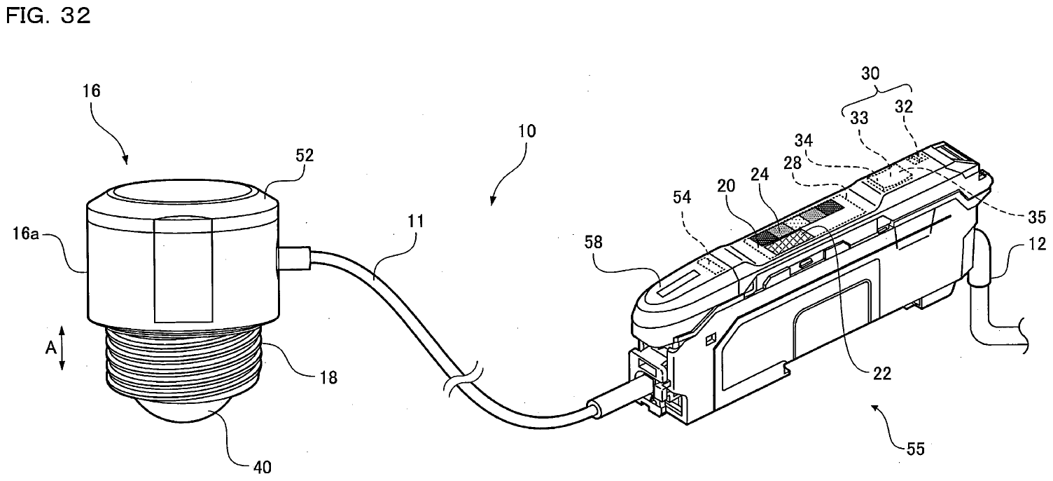

In FIG. 31, another example of the optimization completion screen of FIG. 22 is displayed. Since there is a margin in the display space, the optimization setting contents are collectively displayed on one screen without performing scroll display as illustrated in FIG. 22. Also on this optimization completion screen, the title bar 899 of the “adjust function” is displayed.

Next, still another example of the level meter 10 will be described with reference to FIG. 32. FIG. 32 is a perspective view illustrating still another example of the level meter 10. In FIG. 32, components having the same functions as those of level meter 10 in FIGS. 1 and 28 are denoted by the same reference numerals as those in FIGS. 1 and 28, and the description thereof will not be repeated unless necessary.

In FIG. 32, the level meter 10 includes the sensor unit 16 and a remote controller 55 that can communicate with the sensor unit 16 at a position away from the sensor unit 16. Then, the sensor unit 16 and the remote controller 55 are connected by a communication cable 11. In the level meter 10 of FIG. 32, only the sensor unit 16 is attached to the container 70 that contains the object 72, and the remote controller 55 communicates with the sensor unit 16 at a position away from the container 70.

As illustrated in FIG. 32, the sensor unit 16 has a generally cylindrical shape. The status lamp 52 is provided in the upper part of the sensor unit 16. The remote controller 55 corresponds to the housing 15 in the level meter 10 in FIGS. 1 and 28, and includes a display portion 20 that performs display according to the measured level Y. The display portion 20 can display the bar display 22 and the color gauge 24. In addition, the remote controller 55 includes the operation unit 30 for the user to operate the operation of the level meter 10. Furthermore, the remote controller 55 has the connection portion 12 serving as a connection terminal with an external device. The remote controller 55 also includes a remote state lamp 54. The remote state lamp 54 is lit in the same lighting state as the status lamp 52 of the sensor unit 16.

The display portion 20 of the level meter 10 in FIG. 32 displays various types of information similarly to the display portion 20 of the level meter 10 in FIGS. 1 and 28. The information indicated to the user by the display portion 20 of FIG. 32 is equivalent to the case in FIGS. 1 and 28. The display content by the display portion 20 in FIG. 32 may be simplified according to the size of the display portion 20.

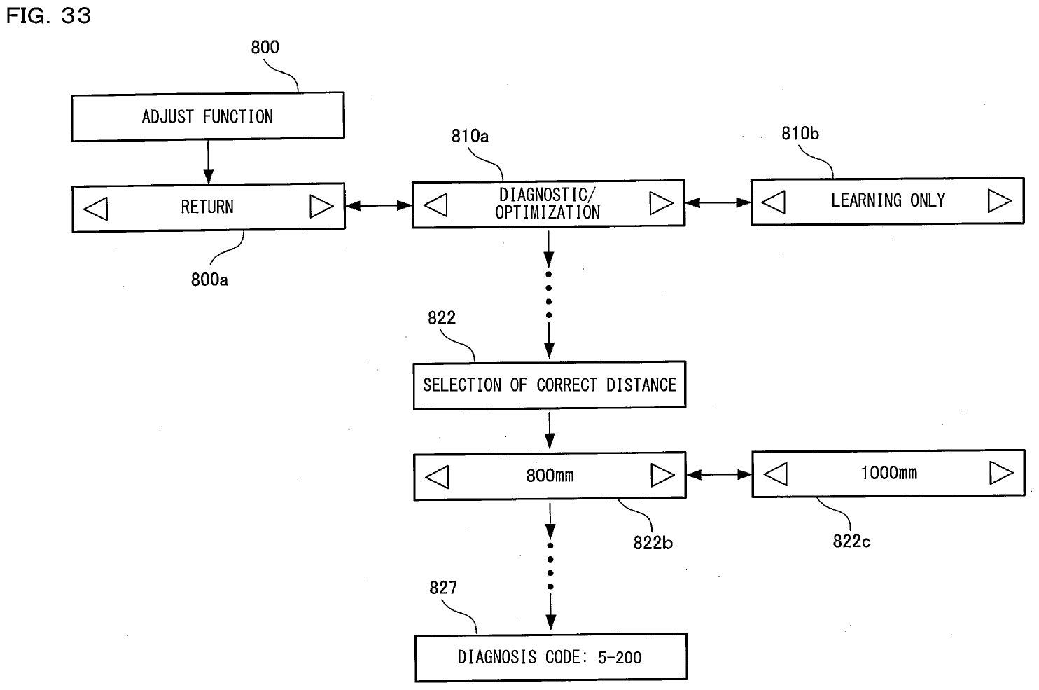

Hereinafter, some of the screens displayed on the display portion 20 of the level meter 10 in FIG. 32 will be described as another example of individual screens in the level meter 10 of FIGS. 1 and 28. FIG. 33 is a view illustrating screen transition of the display portion 20 of the remote controller 55 in the adjustment function 800 (FIG. 10). In the adjustment function 800, a character string is displayed on the display portion 20 of the remote controller 55 instead of the bar display 22 and the color gauge 24. The interface position icon 131 and the reception intensity scale 890 are not displayed on the display portion 20 of the remote controller 55 due to a display space. In addition, only one line of character strings is displayed.

When the adjustment function 800 is started, first, a character string “adjust function” is displayed on the display portion 20. When the menu key 32 is operated in this state, a cancel screen 800a on which the character string “return” is displayed is displayed on the display portion 20. When the menu key 32 is operated in this state, the adjustment function 800 is interrupted, and the display portion 20 returns to the normal measurement mode 500 as illustrated in FIG. 39.

By operating the direction keys 33, the display portion 20 can mutually transition among the cancel screen 800a, the optimization mode selection screen 810a, and the limited mode selection screen 810b. In the display portion 20 of the remote controller 55, the character string “diagnosis/optimization” indicates the optimization mode selection screen 810a. In addition, a character string “learning only” indicates the limited mode selection screen 810b.

When the menu key 32 is operated on the optimization mode selection screen 810a, the processing of the optimization mode 820 of FIG. 11 is started. Here, as another example of the screen of the display portion 20, another example of the screen in the candidate selection (step 822 in FIG. 11) included in the optimization mode 820 and another example of the screen on which the suggestion message is displayed (step 827 in FIG. 11) will be described.

Before the candidate selection in step 822 is performed, a candidate selection message is displayed in the form of a character string “selection of correct distance” in the display portion 20. This message prompts the user to select a numerical value representing the correct distance of the object 72 on the next screen. When the menu key 32 is operated with respect to the candidate selection message, the second candidate confirmation screen 822b is displayed on the display portion 20. A value “800 mm” of the peak candidate is displayed on the second candidate confirmation screen 822b. The second candidate confirmation screen 822b can transition to the third candidate confirmation screen 822c displaying a value “1000 mm” of another peak candidate by operating the direction key 33. In addition, although not illustrated in FIG. 33, the display portion 20 may transition to the first candidate confirmation screen 822a indicating that the container 70 is in the empty state and the fourth candidate confirmation screen 822d on which a character string “not applicable” is displayed by operating the direction keys 33. When the menu key 32 is operated on any of the candidate confirmation screens, the displayed peak candidate is selected as the target peak PS.

The display portion 20 of the remote controller 55 does not display a long suggestion message due to a display space. Therefore, in the display portion 20 of the remote controller 55, the number of the “diagnosis code” (here, 5-200) is displayed instead of the suggestion message. The number of the diagnostic code and the corresponding suggestion message are described in a document (such as an operation manual of the remote controller 55) prepared corresponding to the remote controller 55. The user can check the content of the suggestion message by comparing the displayed diagnostic code with the document.

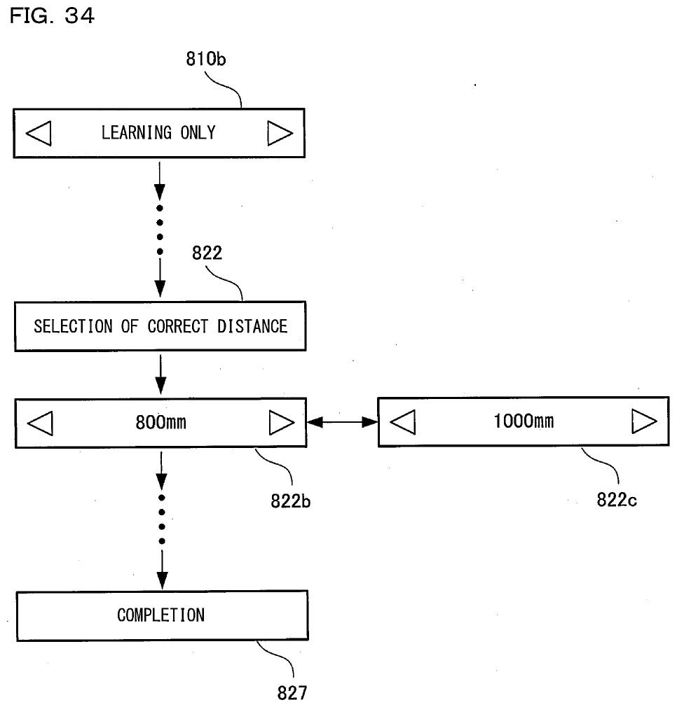

Next, FIG. 34 is a view illustrating screen transition of the display portion 20 of the remote controller 55 in the limited mode 860 (FIG. 13). When the menu key 32 is operated on the limited mode selection screen 810b of FIG. 33 (character string of “learning only”), the limited mode 860 of FIG. 13 is started. Here, as another example of the screen of the display portion 20, another example of the screen in the candidate selection (step 864 in FIG. 13) included in the limited mode 860 and another example of the screen displayed when learning is completed (step 867 in FIG. 13) will be described.

In the limited mode 860, the screen display for candidate selection is similar to the case of the optimization mode 820 of FIG. 33. First, a candidate selection message is displayed on the display portion 20 in the form of a character string “selection of a correct distance”, and a plurality of peak candidates are displayed on a second candidate confirmation screen 822b, a third candidate confirmation screen 822c, and the like that can transition from one another on the next screen. When the menu key 32 is operated on any of the candidate confirmation screens, the displayed peak candidate is selected as the target peak PS.

Even when learning is completed, a long character string is not displayed on the display portion 20 of the remote controller 55. Therefore, when the learning in the limited mode 860 is completed, only “completion” is displayed on the display portion 20 of the remote controller 55.

What is claimed is:

1. A level meter that measures a level of an object stored in a container, the level meter comprising:
a transmission/reception unit including a transmission circuit that transmits a measurement signal for measuring the level and a reception circuit that receives a reflection signal due to reflection of the measurement signal;
a distribution determination unit that determines a reception intensity distribution of the reflection signal with respect to a distance from the level meter based on a reception intensity of the reflection signal received by the reception circuit;
an extraction unit that extracts a peak position and a peak intensity from the reception intensity distribution determined by the distribution determination unit;
a measurement value determination unit that determines a measurement value related to a distance or the level of the object based on the peak position extracted by the extraction unit;
a candidate determination unit that extracts a plurality of combinations of the peak position and the peak intensity by the extraction unit from the reception intensity distribution determined by the distribution determination unit and determines the combinations as a plurality of peak candidates; and
a display configured to display information on the measurement value and the reception intensity corresponding to each of the plurality of peak candidates determined by the candidate determination unit.

2. The level meter according to claim 1, wherein when any one of a plurality of the peak candidates displayed on the display is selected as a target peak, the measurement value determination unit removes the peak candidate other than the target peak from the reception intensity distribution and determines a distance or the level of the object based on the target peak to be the measurement value related to the object.

3. The level meter according to claim 2, wherein after the target peak is selected, the display displays information on the measurement value and the reception intensity corresponding to the target peak as the peak candidate.

4. The level meter according to claim 2, wherein after the target peak is selected, information on the target peak can be erased.

5. The level meter according to claim 1, wherein the display displays a stability of the reception intensity when displaying the information on the measurement value and the reception intensity corresponding to each of a plurality of the peak candidates.

6. The level meter according to claim 1, wherein after the target peak is selected, diagnosis regarding a measurement environment is performed based on the target peak and the reception intensity distribution, and the display displays a suggestion message regarding the measurement environment of the level according to a result of the diagnosis.

7. The level meter according to claim 1, wherein after the target peak is selected, diagnosis regarding a measurement environment is performed based on the target peak and the reception intensity distribution, and the measurement value determination unit executes optimization of a setting necessary for determining a measurement value regarding a distance or the level of the object according to a result of the diagnosis.

8. The level meter according to claim 7, wherein the measurement value determination unit executes optimization of a setting necessary for determining a measurement value related to a distance or the level of the object by applying a predetermined setting corresponding to a classification of a result of the diagnosis.

9. The level meter according to claim 1, wherein a question regarding a measurement condition of the level is displayed on the display, and optimization of a setting necessary for determining a measurement value regarding a distance or the level of the object is executed based on an answer input to the question.
